(19) United States
(12) Patent Application Publication
(10) Pub. No.: US 2013/0002601 A1
(43) Pub. Date: Jan. 3, 2013

(54) TOUCH DEVICE GESTURE RECOGNITION

(76) Inventor: David Harold McCracken, Aptos, CA (US)

(21) Appl. No.: 13/198,541

(22) Filed: Aug. 4, 2011

Related U.S. Application Data
(60) Provisional application No. 61/504,011, filed on Jul. 1, 2011.

(51) Int. Cl. G06F 3/048; G06F 3/044; G06F 3/042; G06F 3/041

(52) U.S. Cl. 345/174; 345/178; 715/863; 345/173; 345/175

(57) ABSTRACT

A method for recognizing a gesture made on a touch sensitive device is provided. The method includes obtaining a record of positions for a touch from a touch device using a pad and initializing a vote count to select each of a plurality of gestures; selecting a method from a plurality of gesture identification methods; for each of the selected methods obtaining a measure of the touch from the touch device using the record of positions; updating the vote count according to the obtained measure; determining the gesture from the touch when a plurality of votes is obtained for the vote count for one of the plurality of gestures; and determining the gesture from the touch according to the gesture having a maximum vote count. Touch sensitive devices for using the above method are provided. A method for ranking gesture identification methods in a device as above is also provided.

### CROSS-RELATED APPLICATIONS

This Application relates, and claims priority to U.S. Provisional Patent Application No. 61/504,011 entitled “Touch Device Gesture Recognition” by David Harold McCracken, filed Jul. 1, 2011, the disclosure of which is incorporated herein by reference in its entirety for all purposes.

This Application is related to U.S. Patent Application entitled “Touch Sensitive Device Adaptive Scaling”, (Attorney Docket No. 70107.326), by David Harold McCracken, assigned to Integrated Device Technology, Inc. filed concurrently with the present disclosure on Aug. 4, 2011 and which is incorporated herein by reference in its entirety for all purposes. This Application is also related to U.S. patent application Ser. No. 13/154,227, filed on Jun. 6, 2011, entitled “Differential Capacitance Touch Sensor” by David Harold McCracken, assigned to Integrated Device Technology, Inc. incorporated herein by reference in its entirety for all purposes.

### BACKGROUND

1. Technical Field

Embodiments described herein generally relate to the field of touch sensitive devices that perform gesture recognition. More particularly, embodiments disclosed herein relate to methods and systems to recognize swipe and tap gestures in touch sensitive devices.

2. Description of Related Art

Capacitive and near-field optical touch sensitive devices typically produce high-resolution position information indicating a touch position on the face of the device only when a finger (or stylus) is touching the ‘sensitive’ face of the device, or touch pad. As the finger approaches or withdraws from the device, the positioning accuracy may become poor. Because data produced by swipes and taps may occur during approach and withdrawal of the finger or stylus, state-of-the-art position data processing interprets these gestures unreliably.

For example, small differential capacitive touch devices may have the problem of unreliably distinguishing a touch gesture as a swipe or a tap. Other examples of touch sensitive devices, such as a mouse or a joystick, do not recognize swipe and tap gestures at all. The small size of a touch pad induces the user to perform motions that become difficult to distinguish for state-of-the-art devices and methods, even when user intentions are clearly distinct.

What is needed is a method and a system for reliable and fast recognition of user gestures in a touch sensitive device.

### SUMMARY

According to embodiments disclosed herein, a method for recognizing a gesture made on a touch sensitive device configured to detect touch motions may include the steps of: obtaining a record of positions for a touch from a touch device using a pad in the touch sensitive device and initializing a vote count to select each of a plurality of gestures. The method may further include the step of selecting a method from a plurality of gesture identification methods, and for each of the selected methods obtaining a measure of the touch from the touch device using the record of positions; updating the vote count according to the obtained measure; determining the gesture from the touch when a plurality of votes is obtained for the vote count for one of the plurality of gestures; and determining the gesture from the touch according to the gesture having a maximum vote count.

Further according to embodiments disclosed herein a method to determine a gesture direction in a touch sensitive device may include the steps of obtaining a gesture record and selecting a method from a plurality of gesture identification methods. Moreover, the method may include for each of the selected methods obtaining a gesture direction from the gesture record; updating a directions array using the gesture direction; and determining the gesture direction using the directions array.

According to embodiments disclosed herein a method to calibrate a touch sensitive device may include the steps of determining the touch level for a ‘no touch’ condition; determining a level difference between a ‘touch’ and a ‘no touch’ condition; and obtaining a touch strength threshold to distinguish a ‘touch’ condition from a ‘no touch’ condition.

According to embodiments disclosed herein a method for ranking gesture interpretation methods in a touch sensitive device may include the steps of: selecting a plurality of gestures to be interpreted; selecting a plurality of gesture interpretation methods to be ranked; providing a selected number of physical gestures corresponding to each of the plurality of gestures; updating a length array for each of the plurality of gestures to be interpreted, for each of the physical gestures provided; and ranking each of the plurality of gesture interpretation methods according to an entry in the length array.

Further according to methods disclosed herein a method for ranking gesture interpretation methods in a touch sensitive device may include the steps of: selecting a plurality of gesture interpretation methods to be ranked; selecting a plurality of physical directions; providing a physical gesture corresponding to a pre-selected type in one of the plurality of physical directions; and obtaining a gesture record from the physical gesture. For each of the plurality of gesture interpretation methods the method for ranking gesture interpretation methods may further include the steps of: updating an array of correct minority accumulators; updating an incorrect majority accumulator; obtaining an overall error; and ranking the plurality of gesture interpretation methods.

Further according to embodiments disclosed herein a touch sensitive device may include a touch pad configured to provide a record of positions for a touch motion made on the touch pad; a memory circuit to store the record of positions, the memory circuit including a set of executable instructions and a processor circuit to execute the set of executable instructions using the stored record of positions, wherein the set of executable instructions may include instructions for recognizing the touch motion from one of a plurality of gestures using a vote count and a plurality of gesture identification methods, wherein the vote count is updated for each of the plurality of gesture identification methods.

According to embodiments disclosed herein a method for ranking a plurality of gesture identification methods for gesture recognition in a touch sensitive device configured to detect touch motions may include the steps of: initializing an array of measure values for each of a plurality of gestures, each array having an entry for each of a plurality of gesture identification methods and providing a number of identifiable touch motions ‘corresponding to each of the plurality of gestures. The method may further include the steps of updating each of the arrays of measure values for each of a plurality of gestures using measures provided by each of the plurality of gesture identification methods; ranking the plurality of gesture identification methods using differences in the array of measures between two different gestures from the plurality of gestures.

These and other embodiments are further described below with reference to the following figures.

### BRIEF DESCRIPTION OF THE DRAWINGS

FIG. 1A illustrates a partial side view of a touch sensitive device and a finger having a range of influence performing a tap motion, according to some embodiments of the present disclosure.

FIG. 1B illustrates a partial side view of a touch sensitive device and a finger having a range of influence performing a tap motion, according to embodiments disclosed herein.

FIG. 1C illustrates a partial side view of a touch sensitive device and a finger having a range of influence performing a tap motion, according to embodiments disclosed herein.

FIG. 1D illustrates a partial side view of a touch sensitive device and a finger having a range of influence performing a tap motion, according to embodiments disclosed herein.

FIG. 2 illustrates a partial side view of a touch sensitive device and a finger having a range of influence performing a swipe motion, according to embodiments disclosed herein.

FIG. 3 illustrates a direction quantization chart according to embodiments disclosed herein.

FIG. 4 illustrates a partial view of a method for gesture interpretation of a touch sensitive device according to methods disclosed herein.

FIG. 5 illustrates a partial view of a method for gesture interpretation of a touch sensitive device according to methods disclosed herein.

FIG. 6 illustrates a partial view of a method for gesture interpretation of a touch sensitive device according to methods disclosed herein.

FIG. 7 illustrates a partial view of a method for gesture interpretation of a touch sensitive device according to methods disclosed herein.

FIG. 8 illustrates a partial view of a method for gesture interpretation of a touch sensitive device according to methods disclosed herein.

FIG. 9 illustrates a partial view of a method for gesture interpretation of a touch sensitive device according to methods disclosed herein.

FIG. 10 illustrates a partial view of a method for gesture interpretation of a touch sensitive device according to methods disclosed herein.

FIG. 11 illustrates a partial view of a method for gesture interpretation of a touch sensitive device according to methods disclosed herein.

FIG. 12 illustrates a flow chart of a method to distinguish a tap gesture from a swipe gesture in a touch sensitive device, according to some embodiments.

FIG. 13 illustrates a flow chart of a method to determine a gesture direction in a touch sensitive device, according to some embodiments.

FIG. 14 illustrates a flow chart of a method to determine a gesture direction in a touch sensitive device, according to some embodiments.

FIG. 15 illustrates a flow chart of a method to calibrate a touch sensitive device, according to some embodiments.

FIG. 16 illustrates a flow chart of a method for ranking gesture interpretation methods in a touch sensitive device according to some embodiments.

FIG. 17 illustrates a flow chart of a method for ranking gesture interpretation methods in a touch sensitive device according to some embodiments.

In the figures, elements having the same designation have the same or similar functions.

### DETAILED DESCRIPTION

Current trends to miniaturization and portability of consumer electronics have resulted in a myriad of appliances including touch sensitive devices with limited dimensions. For the use of these appliances, it is desirable that the touch sensitive device produce fast and reliable gesture recognition, accurately identifying user intent. Embodiments disclosed herein include a data processing method that transforms high resolution but inaccurate data produced by a finger (or stylus) swiping across or tapping on the face of a touch input device into accurate swipe and tap information. Multiple data processing methods may be used to interpret a data set including the gesture. It may be desirable to use a combination of methods to more accurately interpret a wide range of expected data sets. Recognition results from different methods may be combined to produce a result that accurately interprets more data sets than a single method alone. Embodiments of the present disclosure include a general purpose data processing method applicable to any type of touch input device. Furthermore, embodiments disclosed herein may be used for recognition of user gestures other than a ‘tap’ and a ‘swipe’ gesture.

Embodiments of the methods and systems disclosed herein increase the range of applications of touch sensitive devices such as differential capacitive touch devices. Other touch sensitive devices such as mechanical and optical trackballs in cell phones may also benefit from reliable swipe recognition methods and systems as disclosed herein. The ability to reliably recognize taps and to distinguish them from short swipes in touch sensitive devices increases control capabilities without increasing area and form factor of the appliance. Some embodiments of the methods and systems disclosed herein may include use of touch pads. Other embodiments may use touch sensitive devices having smaller dimensions relative to touch pads and touch sensitive screens but having comparable performance regarding swipe and tap recognition. Swipe recognition as in embodiments disclosed herein may also be used by camera makers to enable swiping through a gallery of photographs in the camera while using continuous touch in the other axis, for zoom.

Embodiments disclosed herein provide methods for recognizing and measuring finger swipes and taps on a touch sensitive device such as a capacitive touch position indicator. Touch sensitive devices using methods and systems as disclosed herein may afford high position resolution whenever the user's finger touches or is in close proximity to the sensing surface. According to some embodiments, a higher level of accuracy may be obtained when the finger touches the surface (touch pad) of the touch sensitive device. As the finger approaches or withdraws from the surface, the device may exhibit poor accuracy. Positions reported by a touch sensitive device during approach or withdrawal are included in methods and systems according to some embodiments disclosed herein. This allows the device to recognize swipe and tap gestures, which may be included in the approach and withdrawal motion, with little or no time spent in direct contact with the touch pad. Embodiments disclosed herein provide methods and systems for analyzing the position data produced by swipe and tap gestures to obtain a reliable interpretation of the user's intent. According to some embodiments, the position data used by methods and systems disclosed herein may include portions of a finger motion where the finger is not in direct contact with the touch pad.

In the following description, references to a finger are meant to include a thumb finger. Also, in some embodiments a human finger may be replaced by a touch device such as a stylus, a pointer, or a pen. Proximity detection refers to detection of the finger close to the touch pad but not in direct contact with it, as long as a portion of the device is included in the “range of influence.” Full touch detection means that the finger is in direct contact with the touch pad. A “range of influence” of the finger may be defined as an area or volume surrounding the finger tip such that the finger is detected by the touch sensitive device even when not in direct contact with the touch pad. For a capacitive device the range of influence may be a region where the capacitance of the finger is sufficiently higher than ambient capacitance to be recognized by the touch sensitive device electronics. For an optical device the range of influence may be a region where the finger is close to the focal plane of an optical system in the pad. While not exactly on the focal plane, the finger may be distinguished from the optical background while the device remains within the range of influence. Where reference to a physical device helps to illustrate the operation of the methods and systems disclosed herein, a capacitive device may be used for illustration purposes only, without limiting the scope of the methods and systems disclosed herein. While some embodiments may include capacitive touch sensitive devices, other embodiments consistent with the present disclosure may be applied to capacitive, optical, or any functionally similar touch sensitive device.

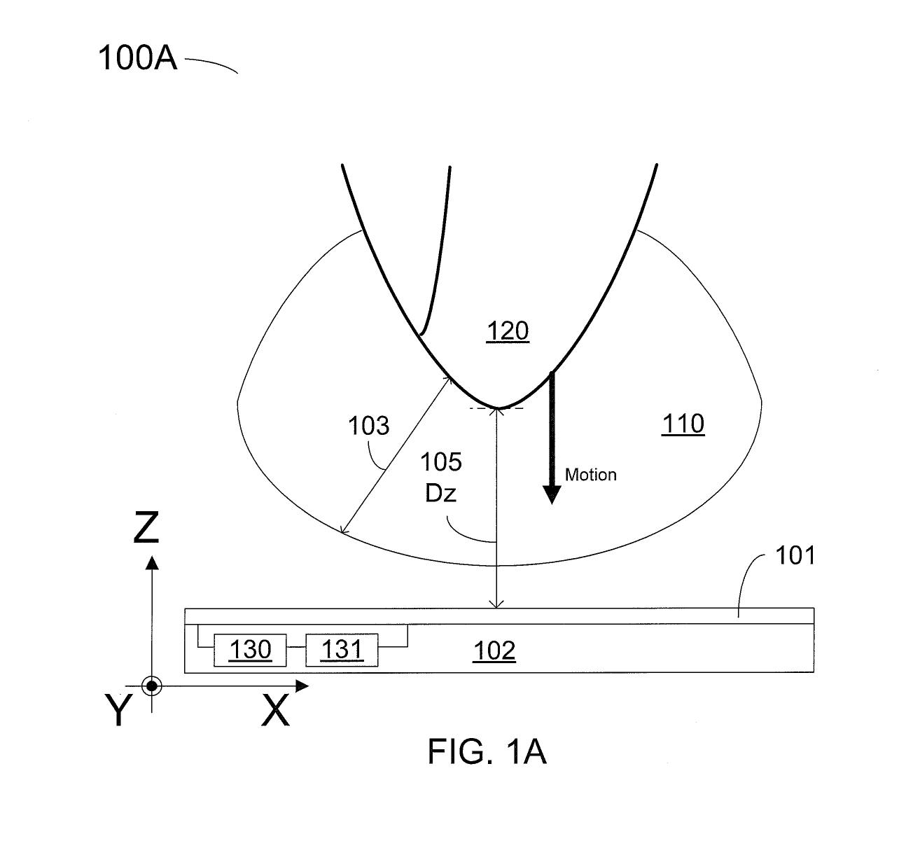

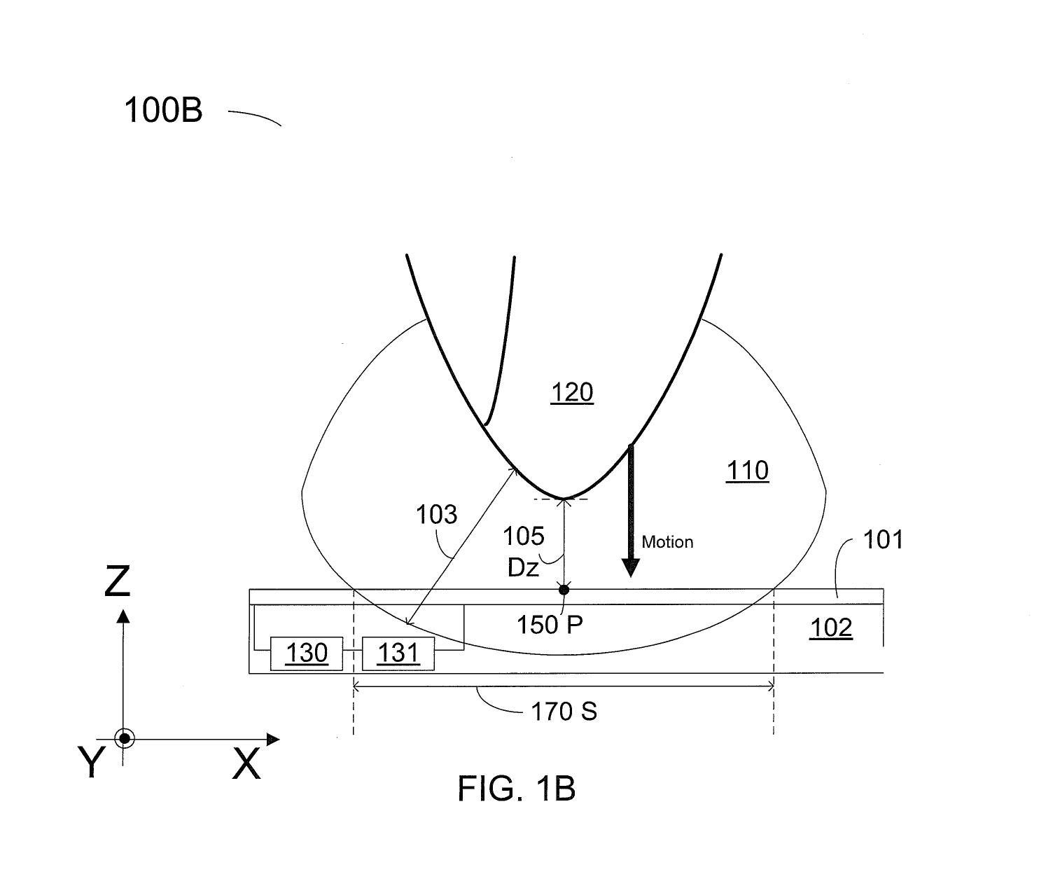

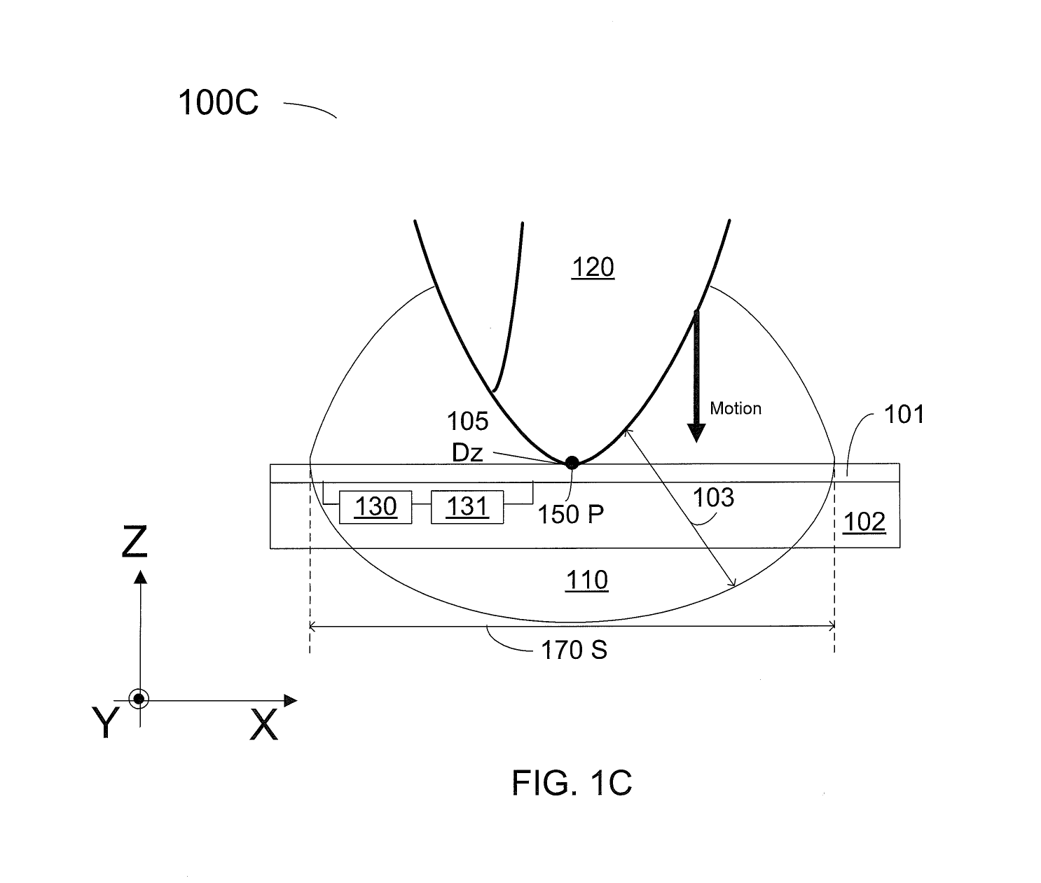

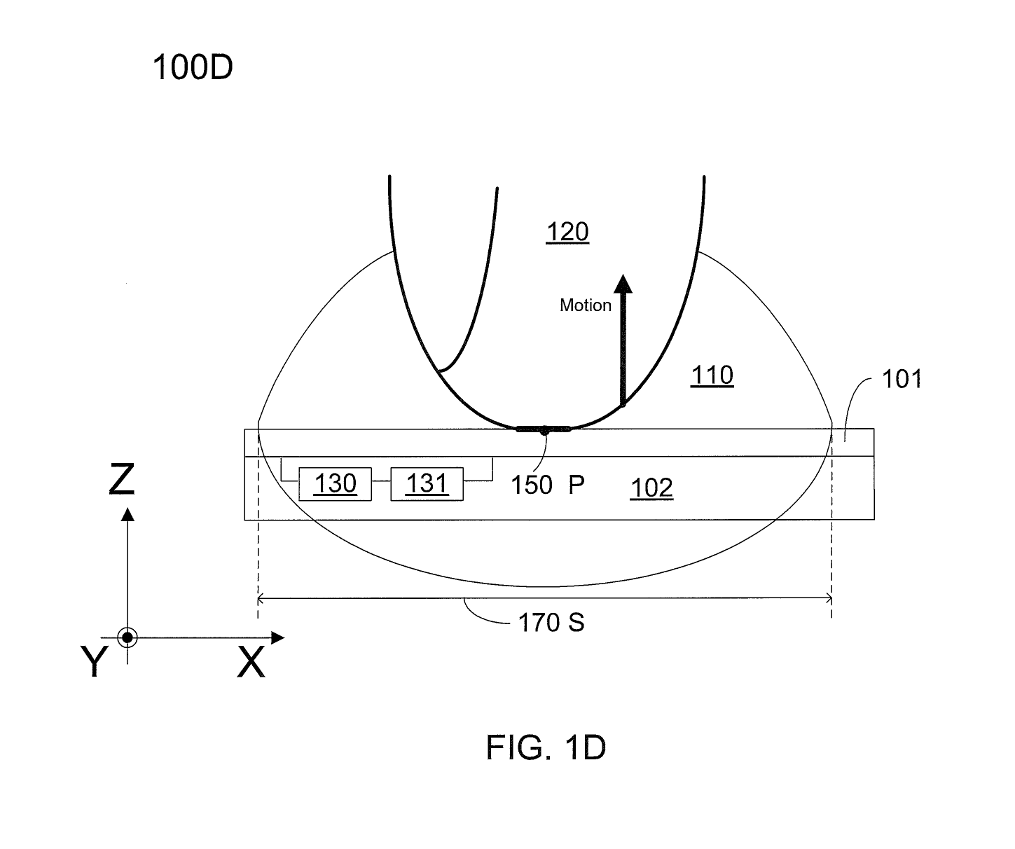

FIGS. 1A-D show a touch gesture corresponding to a ‘tap,’ according to embodiments disclosed herein. In FIGS. 1A-D touch sensitive device 102 having a touch sensitive surface 101, or ‘touch pad,’ is included in an X-Y plane. Touch sensitive device may be a touch sensor such as disclosed in U.S. patent application Ser. No. 13/154,227 filed on Jun. 6, 2011, which is incorporated herein by reference in its entirety, for all purposes. Alternatively, touch sensitive device 102 may be any touch sensitive device capable of detecting a human touch and translating the touch into a position on touch sensitive surface 101. Finger 120 approaches pad 101 in a vertical direction, along a Z axis, as illustrated in FIGS. 1A-D. At any given time, the tip of finger 120 is located at a distance 105 (Dz) above touch pad 101. A sensing mechanism in device 102 is configured to detect finger 120 within a range of influence 110. Range of influence 110 is illustrated schematically in FIGS. 1A-D as an area having a rounded shape. It should be understood that the shape and size of range 110 is three dimensional (3D) in general (a volume) and may vary substantially for different embodiments consistent with the disclosure herein. According to embodiments disclosed herein, once Dz 105 is sufficiently small, a portion of pad 101 may be included within range 110. Under these circumstances, device 102 may be able to determine the presence of finger 120 and find a position 150 (P) for finger 120 in the X-Y plane. Finger 120 in FIGS. 1A-D may be in general any type of touch device, such as a stylus, a pointer, or a human finger including a thumb.

According to embodiments consistent with the disclosure herein, touch sensitive device 102 may include a memory circuit 130 to store a record of positions provided by pad 101. Circuit 130 may also store a set of executable instructions for a processor circuit 131 also included in device 102, according to some embodiments. Circuit 131 may be configured to perform the set of executable instructions provided by memory 130 using the record of positions stored in memory 130. Thus, processor 131 may perform the operations related to methods and procedures consistent with the disclosure herein.

FIG. 1A illustrates a partial side view of configuration 100A including touch sensitive device 102 and finger 120 having range of influence 110. Configuration 100A may occur in a ‘tap’ motion, according to some embodiments, with finger 120 moving down in an approximately vertical direction, as illustrated. In FIG. 1A, Dz 105 is far enough from pad 101 so that its effect is less than a proximity threshold 103 (Tp). According to some embodiments, the presence of finger 120 is not detected nor recorded by device 102 in configuration 1A. Proximity threshold Tp 103 is set for device 102 according to a calibration procedure. The specific value of Tp 103 determines the size of range 110. For example, in some embodiments increasing the sensitivity of device 102 results in an increase of proximity threshold Tp 103, so that finger 120 may be detected at a larger distance Dz 105 from pad 101.

According to some embodiments, together with determining a position P 150 in the X-Y plane for a touch by finger 120, device 102 may also obtain a strength value 170 (S) associated with the touch. The strength value S 170 may indicate whether or not a physical contact is made between finger 120 and pad 101. For example, in some embodiments consistent with the disclosure herein S 170 may be proportional to the area covered by the intersection of range 110 with pad 101. This is illustrated in FIGS. 1B-D, as follows.

FIG. 1B illustrates a partial side view of configuration 100B including touch sensitive device 102 and finger 120 having range of influence 110. Configuration 100B may occur in a ‘tap’ motion, according to some embodiments, with finger 120 moving down in an approximately vertical direction, as illustrated. In FIG. 1B, Dz 105 is short enough so that pad 101 is within range 110. In 100B, the effect of finger 120 on the sensing mechanism in device 102 is higher than at Tp 103 (Dz is less than Tp). However, S 170 of the signal detected by device 102 may still be low for embodiments consistent with FIG. 1B. Device 102 recognizes the proximity of finger 120 and may be able to determine P 150 of the touch on the X-Y plane. Due to a low strength 170, the X-Y position determination may not be accurate. For example, in embodiments consistent with FIG. 1B the magnitude of noise and background drifts in the hardware of device 102 may significantly alter the value of strength 170 and the measurement of P 150.

FIG. 1C illustrates a partial side view of configuration 100C including touch sensitive device 102 and finger 120 having range of influence 110. Configuration 100C may occur in a tap motion, according to some embodiments, with finger 120 moving down in an approximately vertical direction, as illustrated. In FIG. 1C finger 120 is in physical contact with pad 101, exerting a soft pressure on pad 101 so the natural shape of finger 120 is preserved. S is higher than a physical touch threshold, Tt. The device recognizes the condition S>Tt as a physical contact and accurately determines P 150 in the X-Y plane. Threshold Tt may be determined by calibration of device 102. The precise value of Tt may determine the proportion of gestures that are recognized as a ‘tap’ as opposed to the proportion of gestures recognized as a ‘swipe.’ For example, according to some embodiments consistent with FIG. 1C for a given value of Tt, a touch gesture having S<Tt may not likely be recognized as a ‘tap’ and a touch gesture having S>Tt may likely be recognized as a ‘tap.’

FIG. 1D illustrates a partial side view of configuration 100D including touch sensitive device 102 and finger 120 having range of influence 110. Configuration 100D may occur in a ‘tap’ motion, according to some embodiments, with finger 120 moving down in an approximately vertical direction, as illustrated. In FIG. 1D finger 120 is pressed against pad 101, distorting the natural shape of finger 120 and changing P 150 compared to the undistorted shape in FIG. 1C. This may result from an involuntary ‘sideways’ move of finger 120 by the user as it presses on pad 101.

According to embodiments consistent with FIGS. 1A-D, the precision of touch location P may be high between configurations 100C and 100D. When finger 120 is above or just touching the surface, as in configuration 100B or 100C, the user is likely to lose contact with device 102. For example, in configuration 100C, Tt may be smaller than S 170 but very close to S 170, so that in some portions Tt may become slightly larger than S 170. This may cause unintended changes in P 150 as recorded by device 102. Noise and background drift may also significantly alter P 150 when S 170 is small, such as in configuration 100B, and to a lesser extent in configuration 100C.

When pressure causes significant finger distortion, as in configuration 100D, finger shape assumes greater importance compared to position, for device 102. Position 150 can vary significantly and erratically in the range between proximity (100B) and full distorted contact (100D). For a device 102 that is large, this may not be a problem since the user may adjust the trajectory as it gestures with finger 120 along pad 101. For devices 102 that are small, such as a cell phone navigation button, the variation in P 150 may be as large as the full size of the device, providing limited space to the user for correction.

For a finger ‘slide’ gesture, an approaching finger may be ignored until it slightly distorts finger 120 in physical contact. This may be a motion between configurations 100C and 100D in FIGS. 1C-D. During a finger slide, pressure variations may alter the shape of finger 120, impacting P 150. This effect is minor when pressure variations are small compared to strength S 170. In some embodiments, to mitigate pressure variation during slide gestures, device 102 may not record P 150 when finger 120 withdraws from configuration 100C to configuration 100B.

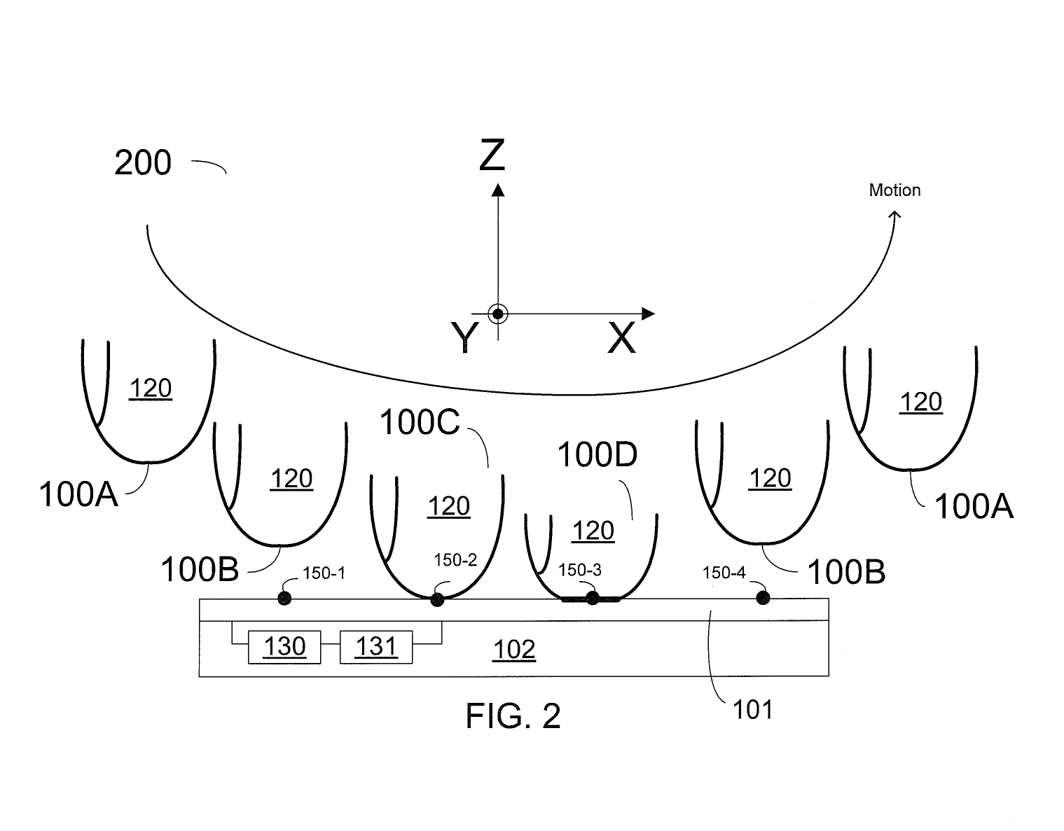

FIG. 2 illustrates a partial side view of touch sensitive device 102 and finger 120 having range 110 performing a swipe motion 200, according to embodiments disclosed herein. In FIG. 2, configurations 100A-D are as described in relation to FIGS. 1A-D above. Positions P 150-1 through 4 are recorded in device 102 as finger 120 changes X, Y and Z coordinates along its trajectory. Strength values S 170-1 through 4 are also recorded for each position P 150. Precision of P 150 at different configurations during slide 200 may be higher between configurations 100C and 100D, which encompasses only a small portion of the user's gesture. In some embodiments, finger movement may not be sufficiently uniform to extrapolate the speed and direction of the swipe from this small segment.

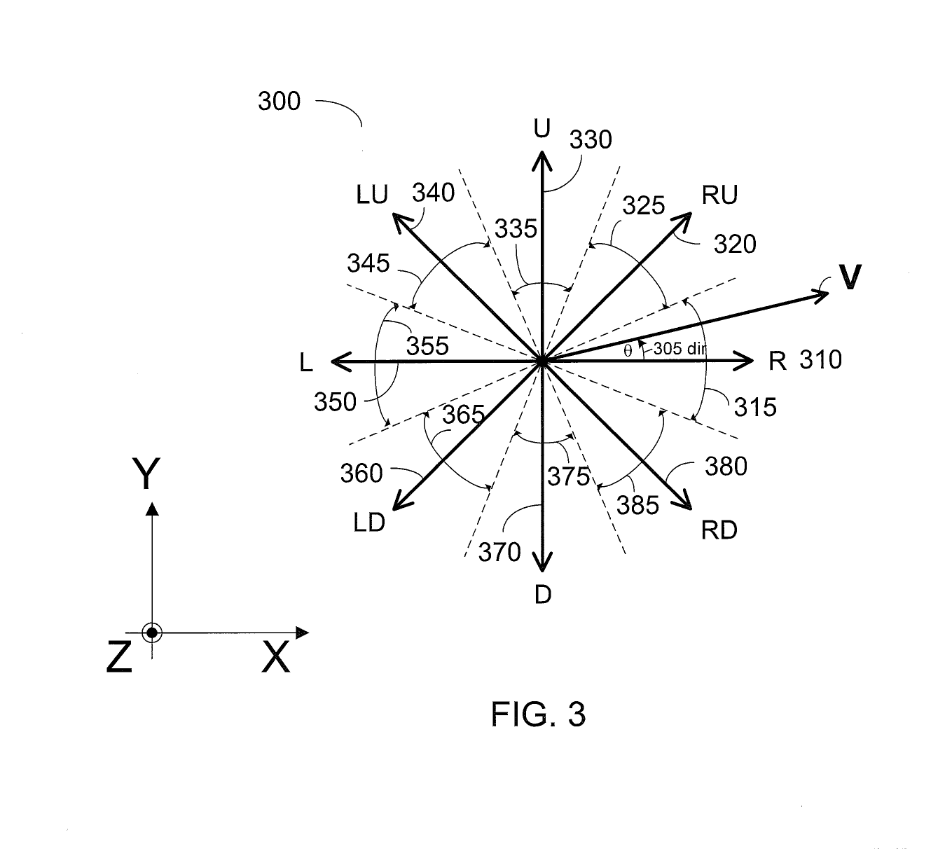

In a tap gesture (cf. FIGS. 1A-D), finger 120 generally follows the same Z axis path as a swipe but does not deliberately move in the X-Y plane. In some embodiments it is desirable to know whether a tap has occurred, while position P 150 is irrelevant. In such cases small position variations may not alter the response of device 102. In some embodiments, even a small device 102 may be divided into top, right, bottom, and left tap areas, rendering a somewhat accurate P 150. An accurate value P 150 may be useful to distinguish gestures and user intent, if positional imprecision could be overcome. In some embodiments consistent with the disclosure herein, it may be desired that device 102 distinguishes a ‘tap’ from a ‘swipe.’ From the user's point of view, swipe 200 (cf. FIG. 2) is a different gesture from the tap including configurations 100A-D (cf. FIGS. 1A-D). Some embodiments consistent with the present disclosure make use of P 150 and S 170 data streams to provide a distinction between taps (FIGS. 1A-D) and swipes (FIG. 2). To do this, some embodiments of the methods and systems disclosed herein use a quantization of motion directions in the X-Y plane, as illustrated in FIG. 3, as follows.

FIG. 3 illustrates a direction quantization chart 300 according to embodiments disclosed herein. Chart 300 is oriented on the X-Y plane in the same X-Y-Z coordinate axis illustrated in FIGS.1A-D, and FIG. 2. A displacement vector V including points P 150 on the X-Y plane has a direction ‘dir’ 305 determined by the angle θ formed by the vector relative to the X axis, as illustrated in FIG. 3. Chart 300 is a partition of the X-Y plane into a number of coarse directions. For any displacement vector V on the X-Y plane, dir 305 will have a precise value given by θ. Given the value of dir 305, a coarse direction may be assigned to V depending on the sector of the X-Y plane including angle θ.

According to some embodiments, coarse directions may include left-right directions (L-R) 350 and 310, respectively; and up-down directions (U-D) 330 and 370, respectively. Some embodiments may also include intermediate directions RU (right-up) 320, LD (left-down) 360, LU (left-up) 340, and RD (right-down) 380. Each of the selected directions 310, 320, 330, 340, 350, 360, 370, and 380 is centered on a corresponding direction interval 315, 325, 335, 345, 355, 365, 375, and 385, respectively. For example, vector V has coarse direction R 310, according to embodiments consistent with FIG. 3.

Embodiments consistent with the disclosure herein may use a plurality of gesture interpretation methods to process P 150, 5170, and dir 305 data streams from touch gestures. The data may be provided by device 102 from the interaction between finger 120 and pad 101. The specific gesture interpretation method used in some embodiments depends of the application desired. Furthermore, some embodiments may use one gesture interpretation method. Some embodiments may combine a plurality of gesture interpretation methods in order to obtain a more accurate result. Each method operates on a record of touch positions P 150, strengths S 170, and directions dir 305 for a finger gesture.

The details of how the records for P 150, S 170, and dir 305 data streams are obtained may depend on the specific configuration of device 102. In the case of a capacitive device, strength is measured by the total capacitance in the area of the touch. For an optical device, strength may be measured by the focus quality of a proximity touch and finger area of a firm touch. In some embodiments consistent with the present disclosure, a device may not provide one or more of the P 150, S 170, and dir 305 data streams. The P 150, S 170, and dir 305 records may include the entire gesture from first to last proximity event detection, according to some embodiments. In some embodiments a subset of the entire gesture may be sufficient to provide an accurate and fast gesture interpretation. In some embodiments, the output of each gesture interpretation method is a vector having entries such as a displacement size, and a direction angle θ. For example, an output of a method may be (|V|, θ) where |V| is the amplitude of displacement vector V representing a swipe amplitude and θ is the value of dir 305, representing the swipe direction. In the case of a ‘tap’ gesture, entries for |V| and θ may also be included. In some embodiments, a ‘tap’ gesture may not include a displacement |V| and a direction θ, but include a position P having X and Y coordinates.

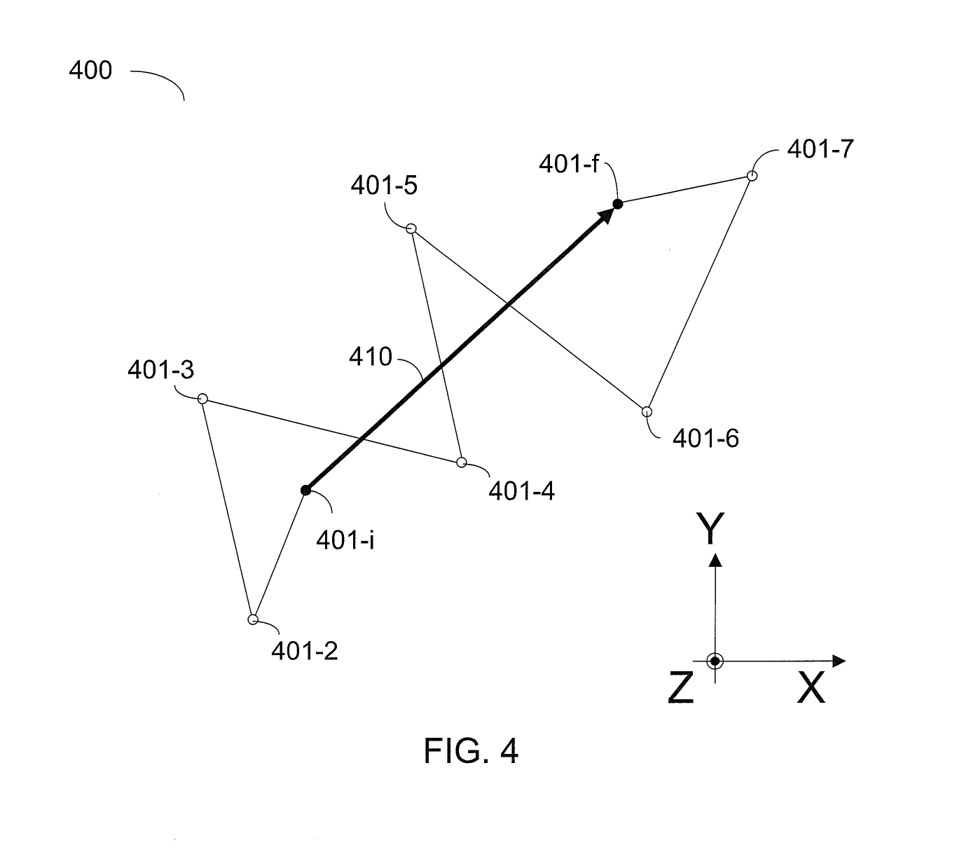

Some embodiments of gesture interpretation methods will be described below in relation to FIGS. 4-11. However, it should be understood that the interpretation methods in FIGS. 4-11 are illustrative only and not limiting. Other gesture interpretation methods may be included in methods and systems consistent with embodiments disclosed herein.

FIG. 4 illustrates a partial view of a method 400 for gesture interpretation of touch sensitive device 102, according to methods disclosed herein. Points 401 in FIG. 4 are recorded values P 150 according to embodiments disclosed herein. For example, points 401 correspond to a finger gesture starting at point 401-i, proceeding in sequence from point 401-2 through point 401-7, and ending at point 401-f. Vector 410 is a displacement vector V from point 401-i to point 401-f. From position 401-i to 401-2 and from 401-7 to 401-f, the path apparently reverses. This may be the case in embodiments where device 102 is a differential capacitive device. In a differential capacitive device an untouched condition such as configuration 100B may produce P 150 not accurately centered below the tip of finger 120. Method 400 ignores the details of positions 401-2 through 401-7, and focuses on vector 410.

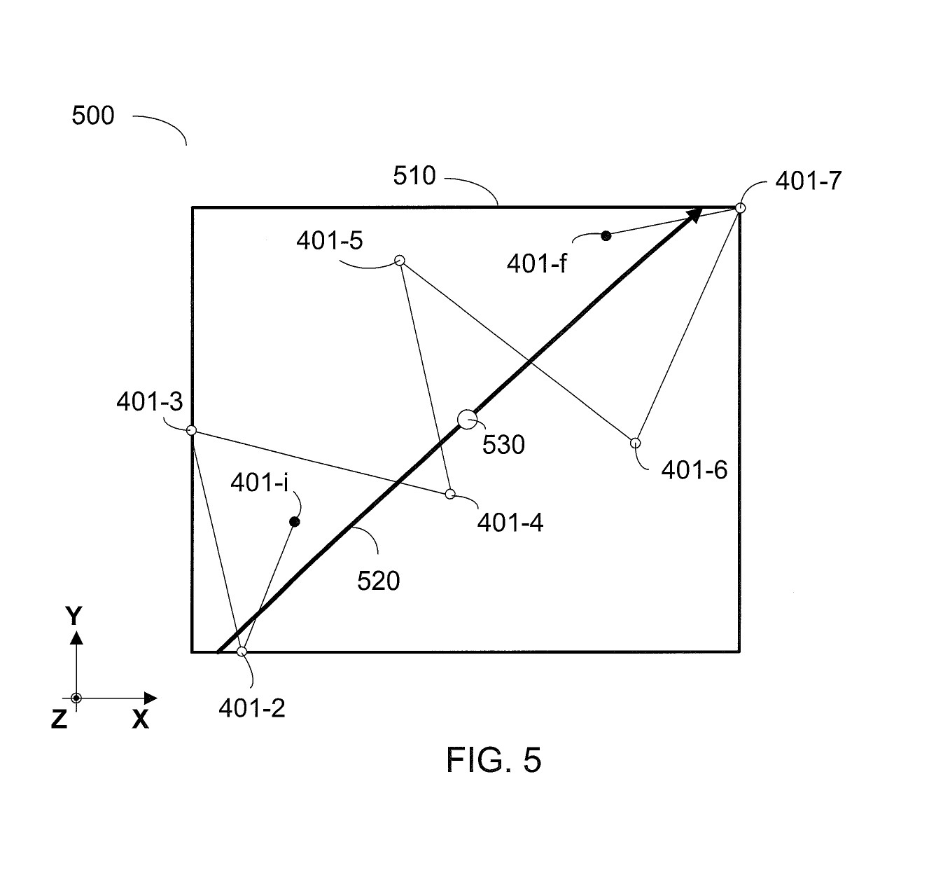

FIG. 5 illustrates a partial view of method 500 for gesture interpretation of touch sensitive device 102 according to methods disclosed herein. The record of points P 150 in FIG. 5 is the same as in FIG. 4. Furthermore, FIG. 5 includes envelope 510. Envelope 510 may include the entire record of points P 150 for a given gesture. According to embodiments consistent with the present disclosure, envelope 510 may be a rectangle having vertically oriented sides and horizontally oriented sides. The vertically oriented side to the left of envelope 510 may include the point P 150 in the gesture record having the lowest X coordinate. The vertically oriented side to the right of envelope 510 may include the point P 150 in the gesture record having the largest X coordinate. The horizontally oriented side at the top of envelope 510 may include point P 150 in the gesture record having the largest Y coordinate. The horizontally oriented side at the bottom of envelope 510 may include point P 150 in the gesture record having the lowest Y coordinate. The distinction of ‘left’, ‘right’, ‘top’ and ‘bottom’ in the above description is determined by the choice of coordinate axes X-Y, as illustrated in FIG. 5. One of regular skill in the art will recognize that the choice of coordinate axis X-Y is arbitrary. Thus, the specific orientation of envelope 510 may change depending on axis orientation, without altering the general concept illustrated in FIG. 5.

Method 500 uses points 401-i and 401-f to determine the direction of resulting vector V 520. According to some embodiments, envelope 510 is used to determine vector length |V|. Vector length |V| is determined from the intersections of the borders of envelope 510 with the line through the center 530 of the envelope 510, having a direction defined by points 401-i and 401-f Method 500 produces a direction determined only by the endpoints 401-i and 401-f. In some embodiments, vector 520 may have a longer length than vector 410 obtained using method 400 (cf. FIG. 4), while having the same direction dir 305 as vector 410.

Methods for gesture interpretation according to embodiments disclosed herein may use a strength percentage in their analysis of the record. The strength percentage may be obtained from the record of strengths S 170 provided by device 102. According to some embodiments, 25%, 50%, and 75% strength levels may be used to filter out weaker points from a given gesture record. Discounting weaker points reduces proximity position errors, such as in configuration 100B (cf. FIG. 1B). Strength percentage levels may be computed using methods discussed herein, such as those discussed below.

Searching the gesture record for the point having the highest S 170 value (the strongest point). Separating the gesture record in a first portion and a second portion. The first portion including the first point through a landmark point. The second portion including the points in gesture record not included in the first portion and including the last point. The selection of the landmark point dividing the first portion and the second portion may vary according to the method. In some embodiments the landmark point may be the strongest point in the gesture record. In some embodiments the landmark point may be the middle point in the sequence forming the gesture record. Further according to some embodiments, the landmark point may be the point in the gesture record closest to the center 530 of an envelope obtained as envelope 510 (cf. FIG. 5). In some embodiments the landmark point may be the point in the gesture record closest to an average point of the entire gesture record. According to some embodiments consistent with the disclosure herein, the first portion of the gesture record may be a begin phase including the starting point, and the second portion may be an end phase including the end point.

In some embodiments, finding strength percentage levels includes dividing the first portion into three levels. A 25% level includes points having S 170 greater than that of the first point by at least 25% of the difference between S 170 for the first point and S 170 for the strongest point. Similarly, 50% and 75% levels identify progressively stronger levels. Thus, according to embodiments disclosed herein a 25% level may include more points than a 50% level, and a 50% level may include more points than a 75% level. Furthermore, in some embodiments consistent with the above description the first point may be excluded altogether from the 25% level, the 50% level, and the 75% level in the first portion. Moreover, the 75% level may be a subset of the 50% level, and the 50% level may be a subset of the 25% level, in the first portion.

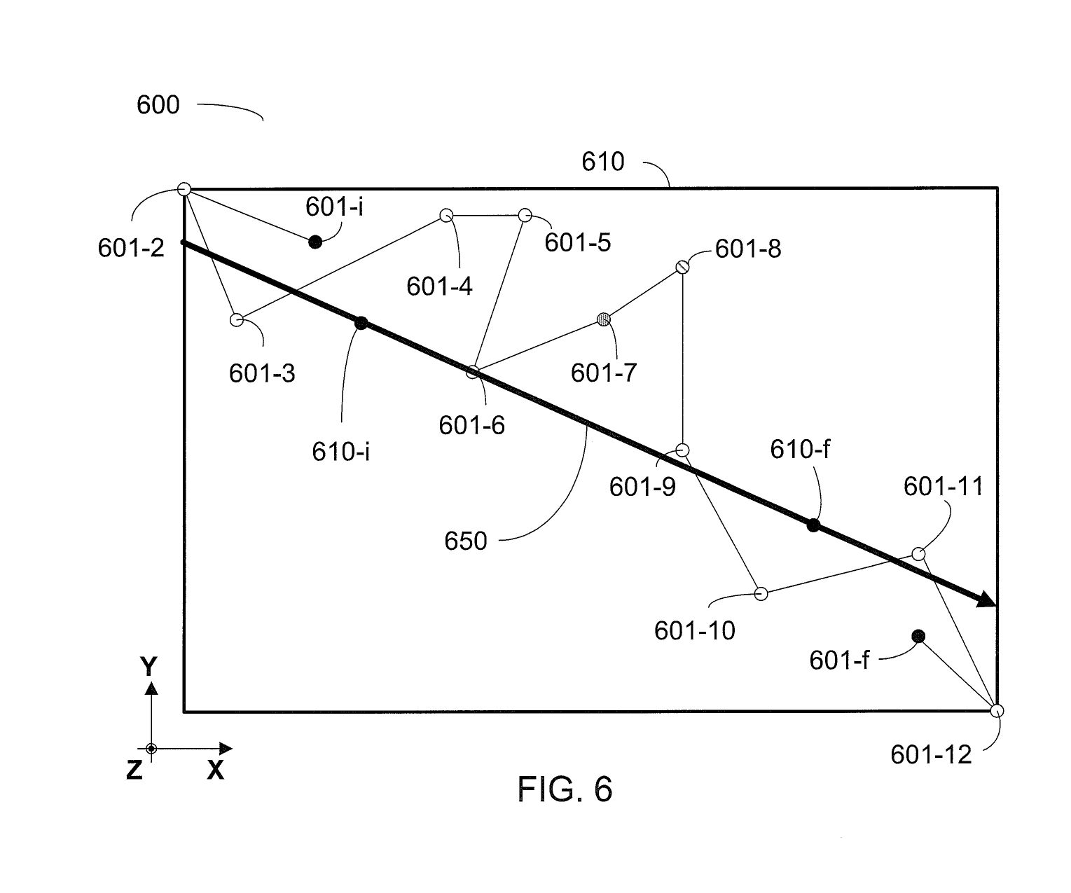

In some embodiments, finding strength percentage levels also includes dividing the second portion into three levels in a similar manner as the first portion. Thus, a 25% level includes points having S 170 greater than that of the last point by 25% of the difference between S 170 for the last point and S 170 for the strongest point. Similarly, 50% level and 75% level identify progressively stronger levels. Thus, in some embodiments consistent with the above description the last point may be excluded altogether from the 25% level, the 50% level, and the 75% level in the second portion. Moreover, the 75% level may be a subset of the 50% level, and the 50% level may be a subset of the 25% level, in the second portion. The use of strength levels in a gesture identification method according to some embodiments will be illustrated below in relation to FIGS. 6-11.

FIG. 6 illustrates a partial view of method 600 for gesture interpretation of touch sensitive device 102 according to methods disclosed herein. In FIG. 6 envelope 610 is obtained for all points 601 in a gesture record. The gesture record starts at point 601-i and proceeds through points 601-2 to 601-12 until end point 601-f. In some embodiments, envelope 610 may be obtained for a subset of all the points 601 in a gesture record. The subset may be obtained from a strength percentage level in a begin phase and an end phase of the gesture record. For example, some embodiments of method 600 may select all points 601 in a 25% level in the begin phase and all points 601 in a 25% level in the end phase to form envelope 610. Some embodiments may use any other strength percentage level to select points 601 from the gesture record. Furthermore, the landmark point used for selecting the begin phase and the end phase in method 600 may vary according to different applications. Some embodiments may use the mid-sequence point (such as 601-7 in FIG. 6) as the landmark point. Note that the strongest point in the gesture sequence may be point 601-8. Thus, the strongest point in the gesture record may not be the same as the landmark point (601-7, in FIG. 6).

Resulting vector V 650 is obtained by the direction determined from point 610-i to point 610-f. The magnitude |V| of vector 650 may be determined by envelope 610, as illustrated in FIG. 6. Note that in some embodiments consistent with method 600, vector 650 may not pass through the center of envelope 610. Furthermore, points 610-i and 610-f may not correspond to physical touch points, and may be ‘virtual’ begin- and end-points, respectively. In embodiments consistent with method 600 points 610-i and 610-f may be obtained according to strength percentage levels, as follows.

Point 610-i may be the average position of points included in a pre-determined percentage level for the begin phase. The pre-determined strength percentage level may be any of 25%, 50%, or 75%, or any other percentage level obtained during a calibration procedure. In some embodiments, the pre-determined percentage level to select point 610-i may be the same as the percentage level used to select envelope 610. Likewise, point 610-f may be the average position of points included in the same pre-determined percentage level for the end phase. The vector formed by these two points is extended in both directions to the edges of envelope 610 to form vector 650.

Further according to some embodiments consistent with method 600, envelope 610 may include all points in a gesture record. In such case, point 610-i may be the average of all points in the begin phase and point 610-f may be the average of all points in the end phase.

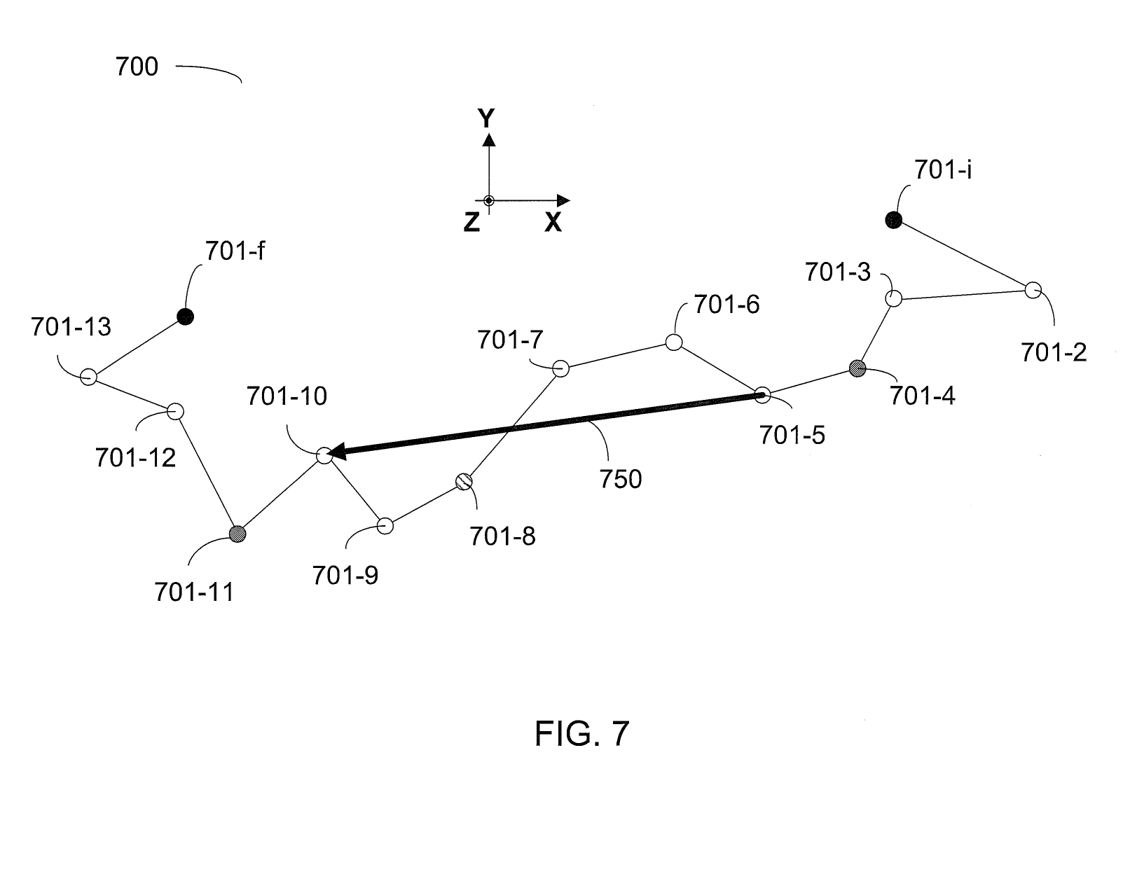

FIG. 7 illustrates a partial view of method 700 for gesture interpretation of touch sensitive device 102 according to methods disclosed herein. Gesture record may include begin point 701-i moving from points 701-2 through 701-13, to point 701-f. In embodiments consistent with method 700 the strongest point in the gesture record is selected. For example, point 701-8 in FIG. 7. The gesture record is traversed from point 701-8 toward point 701-i (in reverse sequence), stopping at any point that is weaker than a pre-determined strength percentage level. This is the begin point of the result vector. For example, if a 50% percentage level is selected in FIG. 7, point 701-4 may have strength S 170 below the 50% strength level determined between point 701-8 and 701-i. Thus, point 701-5 is selected as the starting point for resulting vector V 750.

Similarly, the end point of vector 750 is found by traversing the gesture record from point 701-8 towards point 701-f. The procedure stops at any point that is weaker than the same pre-determined strength percentage level as in the selection of starting point 701-5. For example, if a 50% percentage level is selected in FIG. 7, point 701-11 may have strength S 170 below the 50% strength level determined between point 701-8 and 701-f. Thus, point 701-10 is selected as the end point for resulting vector V 750.

According to the above description, different embodiments of method 700 may use different pre-selected strength percentage levels other than 50%. For example, a percentage level of 25% may be used, or 75%, or any other percentage value. The precise value of the percentage level may be pre-determined by a calibration procedure where the best result is selected according to a user and a desired application.

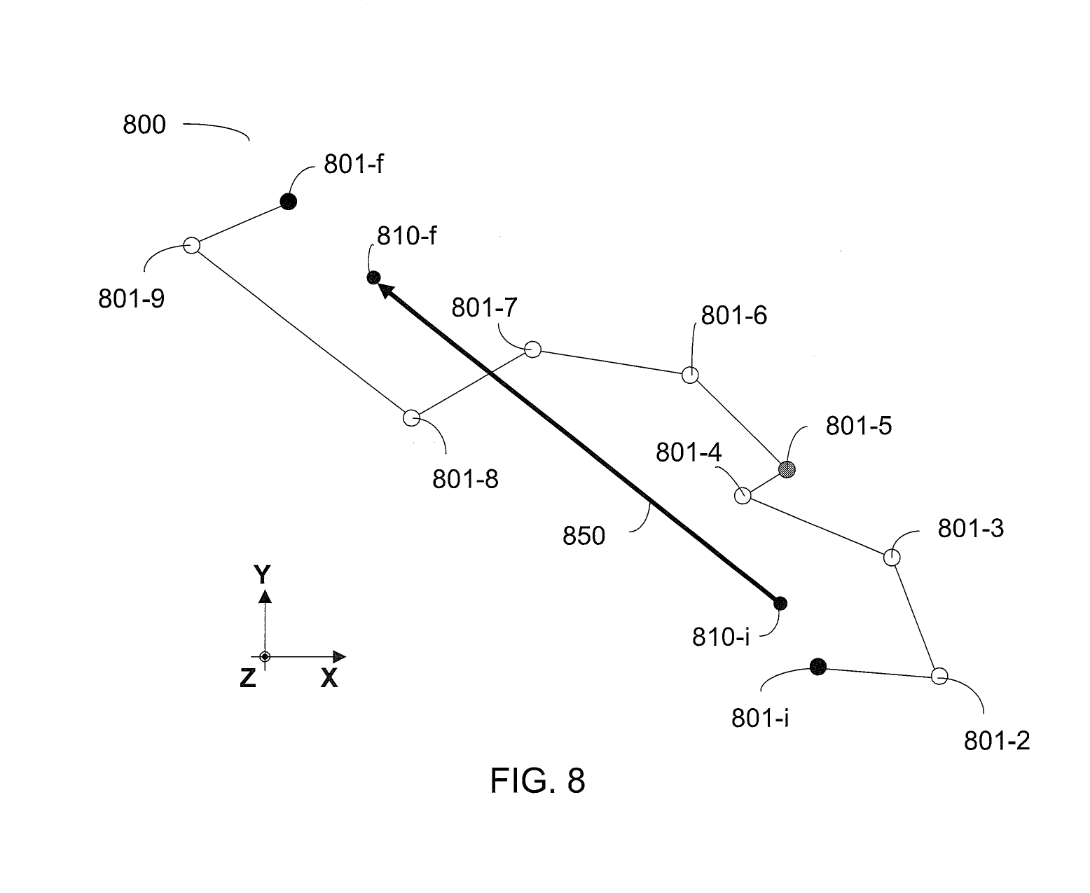

FIG. 8 illustrates a partial view of method 800 for gesture interpretation of touch sensitive device 102 according to methods disclosed herein. In method 800 the begin phase and the end phase of gesture record are split using landmark point 801-5 corresponding to the mid-sequence point. Thus, points 801-i and 801-2 through 801-5 are included in the begin phase. Accordingly, points 801-6 through 801-f are included in the end phase. A resulting vector V 850 may be obtained similarly to vector 650 using envelope 610 of all points in the gesture record. The direction of vector V 850 may be obtained by joining the average of the begin phase points 810-i to the average of the end phase points 810-f. In some embodiments, a strength percentage level method may be applied in connection with method 800, as described above in relation to FIG. 6. Thus, an envelope may be obtained including points in a selected percentage strength level of the begin phase and the end phase.

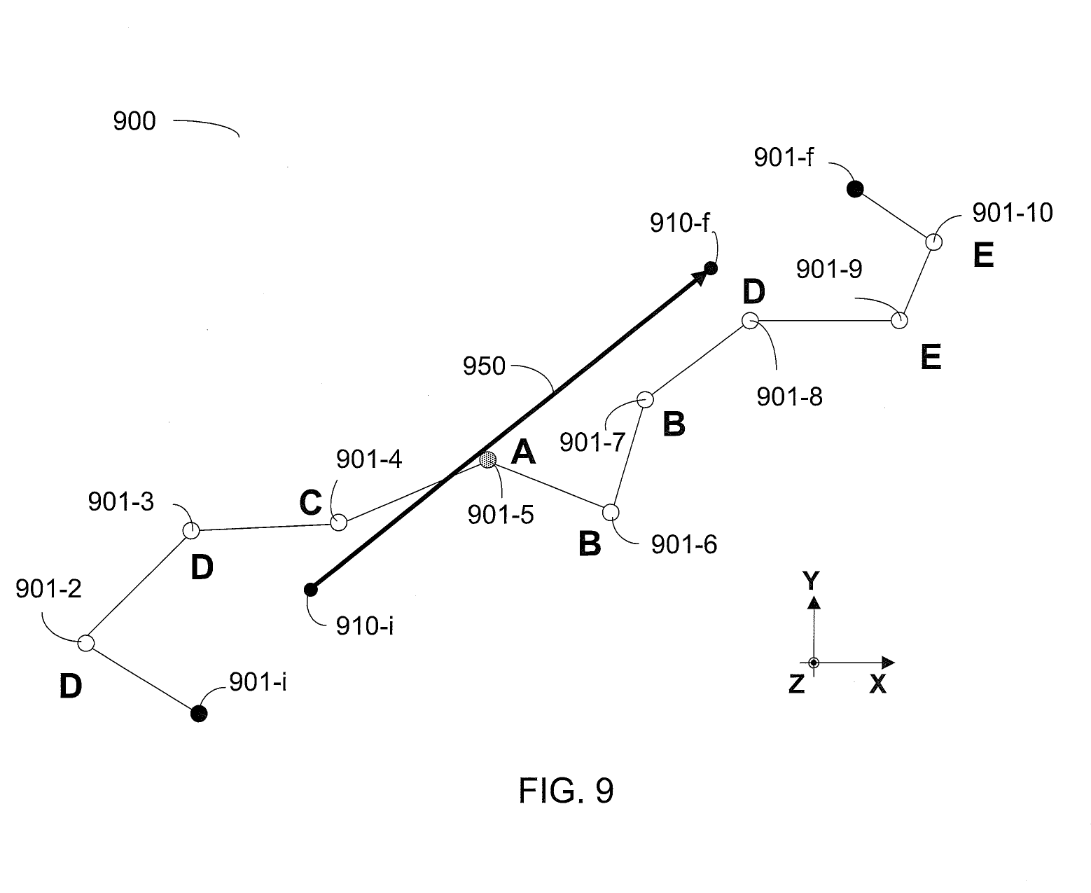

FIG. 9 illustrates a partial view of method 900 for gesture interpretation of a touch sensitive device according to methods disclosed herein. In method 900 the begin phase and the end phase of gesture record are split using landmark point 901-5 corresponding to the strongest point in the sequence. Thus, points 901-i and 901-2 through 901-5 are included in the begin phase. Accordingly, points 901-6 through 901-f are included in the end phase. A resulting vector V 950 may be obtained similarly to vector 650, using an envelope of all points in the gesture record. The direction of vector V 950 may be obtained by joining the average of the begin phase points 910-i to the average of the end phase points 910-f. In some embodiments consistent with method 900, a resulting vector V may be obtained similarly to vector 750 according to method 700 (cf. FIG. 7).

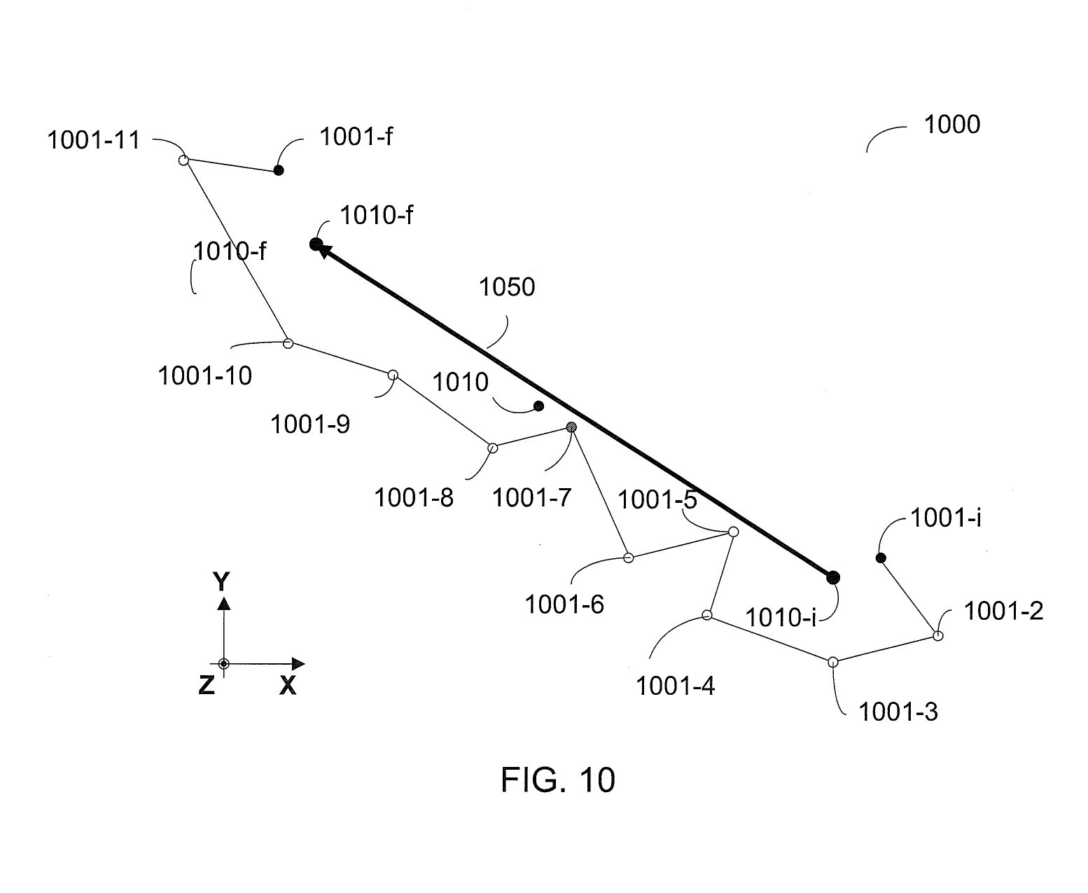

FIG. 10 illustrates a partial view of method 1000 for gesture interpretation of touch sensitive device 102 according to methods disclosed herein. In method 1000 the begin phase and the end phase of gesture record are split using landmark point 1001-7 closest to point 1010. According to embodiments consistent with method 1000, point 1010 may be the average of all points in the gesture sequence. Thus, points 1001-i and 1001-2 through 1001-7 are included in the begin phase. Accordingly, points 1001-8 through 1001-f are included in the end phase. A resulting vector V 1050 may be obtained similarly to vector 650, using an envelope of all points in the gesture record. The direction of vector V 1050 may be obtained by joining the average of the begin phase points 10104 to the average of the end phase points 1010-f. In some embodiments, a strength percentage level method may be applied in connection with method 1000, as described above in relation to FIG. 6. Thus, an envelope may be obtained including points in a selected percentage strength level of the begin phase and the end phase.

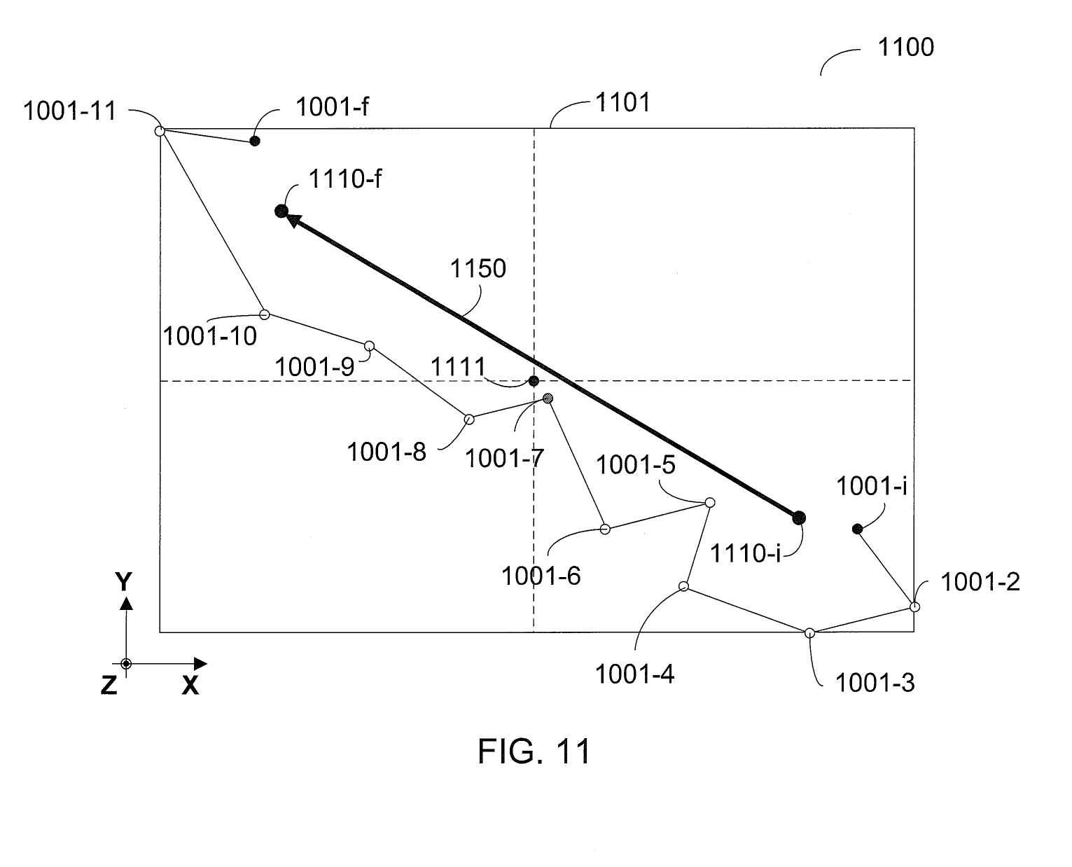

FIG. 11 illustrates a partial view of method 1100 for gesture interpretation of touch sensitive device 102 according to methods disclosed herein. The gesture record in FIG. 11 is the same as in FIG. 10, for illustration purposes only. In method 1100 the begin phase and the end phase of gesture record are split using landmark point 1001-7 closest to point 1111. According to embodiments consistent with method 1100, point 1111 may be the center of envelope 1101. Envelope 1101 may be obtained using all points in the gesture sequence. Thus, points 1001-i and 1001-2 through 1001-7 are included in the begin phase. Accordingly, points 1001-8 through 1001-f are included in the end phase. A resulting vector V 1150 may be obtained similarly to vector 650, using an envelope of all points in the gesture record. The direction of vector V may be obtained by joining the average of the begin phase points 1110-i to the average of the end phase points 1110-f. In some embodiments, a strength percentage level method may be applied in connection with method 1100, as described above in relation to FIG. 6. Thus, an envelope may be obtained including points in a selected percentage strength level of the begin phase and the end phase. The envelope may be obtained as in FIG. 6 by finding a shape (e.g. a rectangle) that includes all the selected points, so that no selected point is outside of the envelope.

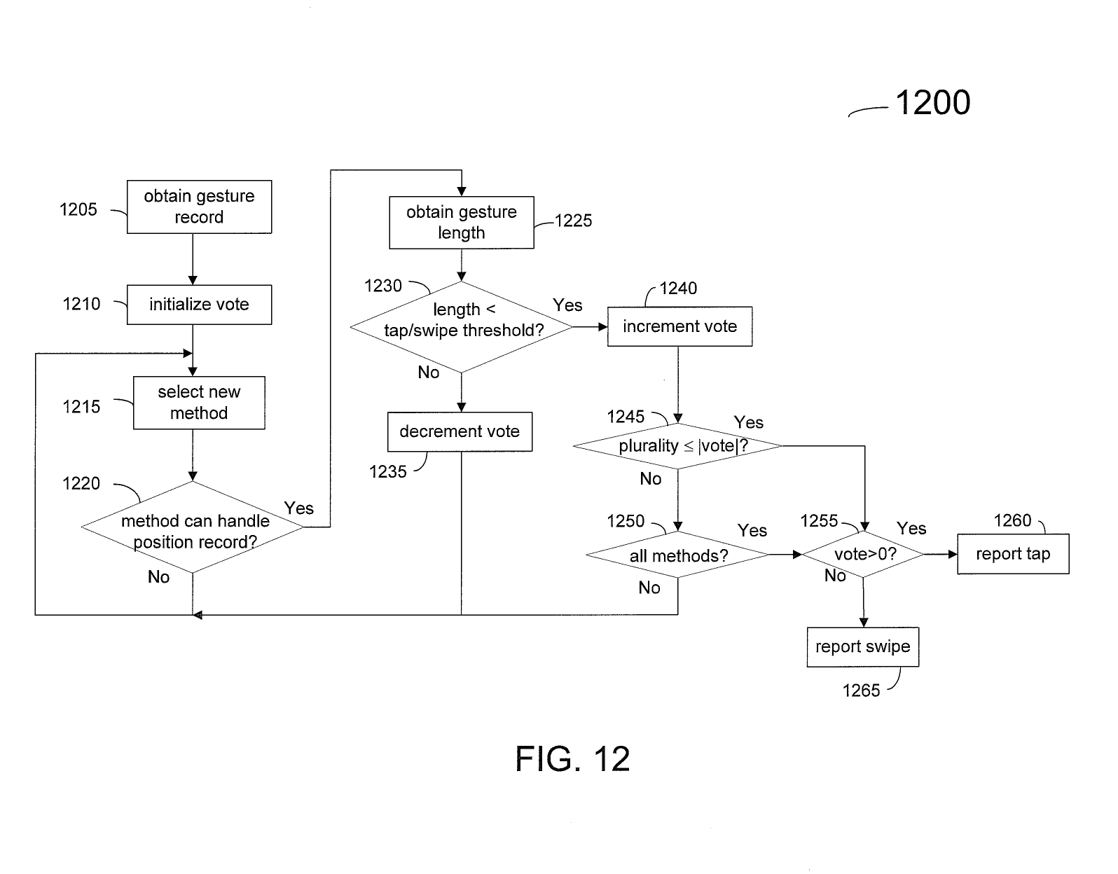

FIG. 12 illustrates a flow chart of method 1200 to distinguish a tap gesture from a swipe gesture in touch sensitive device 102, according to some embodiments. In step 1205 a gesture record is obtained from device 102. In step 1210 a vote value for a given gesture is initialized. For example, some embodiments of method 1200 initialize the vote value to zero (0). In step 1215 a method for gesture identification is selected from a plurality of gesture identification methods. In some embodiments, the selection in step 1215 may be from any one of methods 400-1100 described above (cf. FIGS. 4-11). Some embodiments consistent with method 1200 may include a broader selection of gesture identification methods than methods 400-1100. In general, any method using a gesture sequence provided by device 102 and providing a resulting vector V in the X-Y plane having magnitude |V| and a direction dir 305 may be selected in step 1215. Step 1215 may be performed by processor circuit 131 in device 102 while proceeding in sequence through a pre-determined list of gesture identification methods. The pre-determined list of gesture identification methods may be prepared by a user during a calibration process, or a setup process for device 102 prior to using device 102.

In step 1220 a determination is made whether or not the interpretation method selected in step 1215 is able to provide a vector V from the gesture record. If the selected method is not able to provide vector V, then a new interpretation method is selected and method 1200 is repeated from step 1215. When the selected interpretation method is able to provide V, in step 1225 a gesture length is obtained as |V|. In step 1230 gesture length |V| is compared to a pre-selected tap/swipe threshold ‘tst.’ If |V| is greater than or equal to tst, then in step 1235 a vote value is decremented and method 1200 is repeated from step 1215. According to some embodiments, step 1235 decrements the vote value by one (1).

If |V| is smaller than tst in step 1230, then the vote value is incremented in step 1240. In some embodiments step 1240 may increment the value of vote by one (1). In step 1245 the absolute value of vote is compared to a preselected plurality value. The plurality value may be equal or greater than 50% of the total number of methods to be selected in step 1215. If the absolute value of vote is greater than or equal to plurality in step 1245, then no more methods are selected and in step 1255 the value of vote is queried. If vote is greater than zero (0), then a ‘tap’ gesture is reported in step 1260. If the value of vote is less than or equal to zero (0) in 1255, then a ‘swipe’ gesture is reported in step 1265.

If the absolute value of vote is less than plurality in step 1245, then step 1250 queries if all methods have been considered. If there are methods not yet considered, then method 1200 is repeated from step 1215. If all methods have been considered, then method 1200 proceeds as described form step 1255.

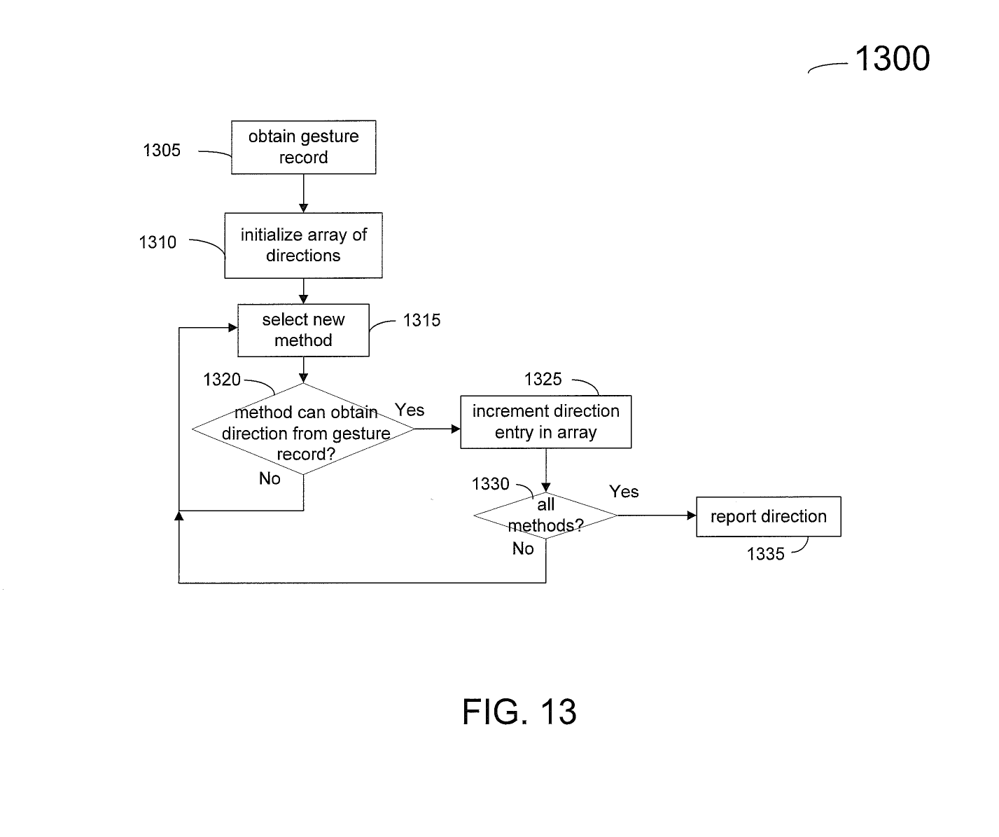

FIG. 13 illustrates a flow chart of method 1300 to determine a gesture direction in touch sensitive device 102, according to some embodiments. Step 1305 may be as described above in relation to step 1205 in method 1200 (cf. FIG. 12). In step 1310 an array of directions is initialized. In some embodiments, the array of directions has a number of entries equal to the number of coarse directions included in direction quantization chart 300 (cf. FIG. 3). Further according to some embodiments of method 1300, step 1310 includes placing a zero (0) in each of the entries of the directions array. Step 1315 may be as described in relation to step 1315 in method 1200 (cf. FIG. 12). In step 1320 a decision is made whether the method selected in step 1215 is able to determine dir 305 from the gesture record. When the gesture identification method is unable to determine dir 305, then method 1300 is repeated from step 1315. When gesture identification method is able to provide dir 305, then the entry in the directions array corresponding to the coarse direction in chart 300 that includes the value dir 305 is incremented in step 1325. In step 1330 it is determined whether or not all identification methods have been considered. When an identification method has not been considered, then method 1300 is repeated from step 1315. When all identification methods have been considered, then a direction is reported in step 1335. According to some embodiments, the direction reported in step 1335 is the direction from chart 300 associated to the entry in the directions array that has the largest value.

According to some embodiments of method 1300, the directions array may have eight (8) entries, corresponding to the R, L, U, D, RU, LU, RD, and LD directions in direction quantization chart 300 (cf. FIG. 3). Other embodiments may have a larger or smaller number of entries in the directions array, depending on the level of quantization of directions chart 300.

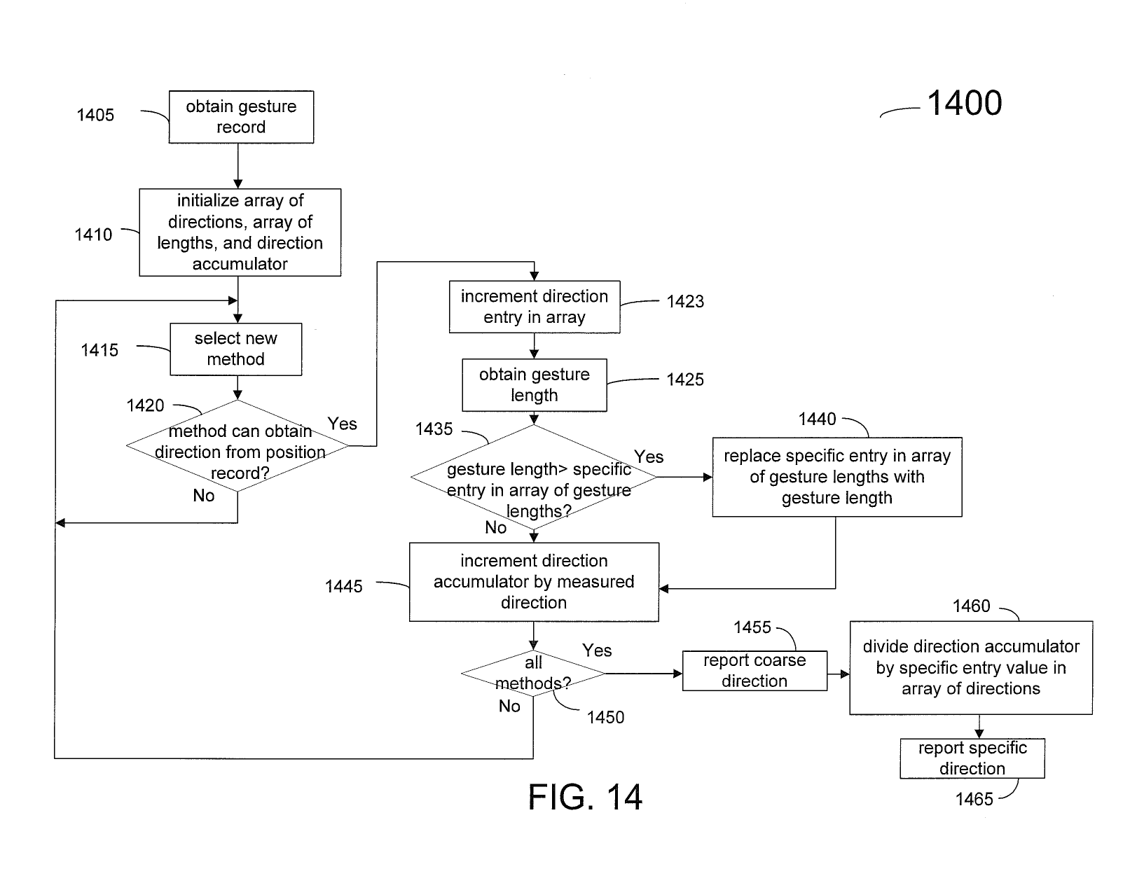

FIG. 14 illustrates a flow chart of method 1400 to determine a gesture direction in touch sensitive device 102, according to some embodiments. Step 1405 may be as described in relation to step 1205 in method 1200 above (cf. FIG. 12). Step 1410 is an initialization step including a directions array, a lengths array, and a direction accumulator. In some embodiments, the size of the directions array and the lengths array is the same, and is equal to the number of coarse directions included in quantized directions chart 300 (cf. FIG. 3). According to embodiments consistent with method 1400, step 1410 sets all entries in each of the directions array and lengths array to zero (0). Also, step 1410 may set the direction accumulator to zero (0). Step 1415 may be as described in relation to step 1215 in method 1200 above (cf. FIG. 12). Step 1420 may be as described in relation to step 1320 in method 1300 above (cf. FIG. 13). Step 1423 may be as described in relation to step 1325 in method 1300 above (cf. FIG. 13). Step 1425 may be as described in relation to step 1225 in method 1200 above (cf. FIG. 12).

In step 1435 gesture length |V| provided in step 1425 is compared to the specific entry in the lengths array. In some embodiments of method 1400, the entry in the lengths array selected in step 1435 is the one corresponding to the coarse direction determined in step 1423. For example, step 1423 may use a given identification method to determine that dir 305 corresponds to coarse direction RU 325 (cf. FIG. 3). Thus, length |V| from step 1425 is compared to the entry in lengths array corresponding to the RU 325 coarse direction. If |V| is larger than the entry selected in step 1435, then the selected entry in the lengths array is replaced by |V| in step 1440. In step 1445 the direction accumulator is incremented by the measured direction as in step 1423. The value used in step 1445 to increment the direction accumulator may be dir 305 as calculated by the identification method selected in step 1415, according to some embodiments. If there are identification methods still to be selected, as determined in step 1450, then method 1400 is repeated from step 1415. If step 1450 determines that all identification methods have been selected, then a coarse direction is reported in step 1455. Step 1455 may be as described in detail with respect to step 1335 in method 1300 above (cf. FIG. 13). In step 1460 the direction accumulator is divided by the specific entry value in the array of directions. The result is reported in step 1465 as an averaged specific direction dir 1490 associated with the gesture. According to some embodiments, step 1465 may also include a report of the gesture length in the entry of the gesture length array corresponding to the coarse direction reported in step 1455.

Note that according to embodiments consistent with method 1400, dir 1490 may be more accurate than a specific value dir 305 because value dir 1490 includes a plurality of gesture identification methods. Value dir 305 is associated with a single gesture identification method, according to some embodiments.

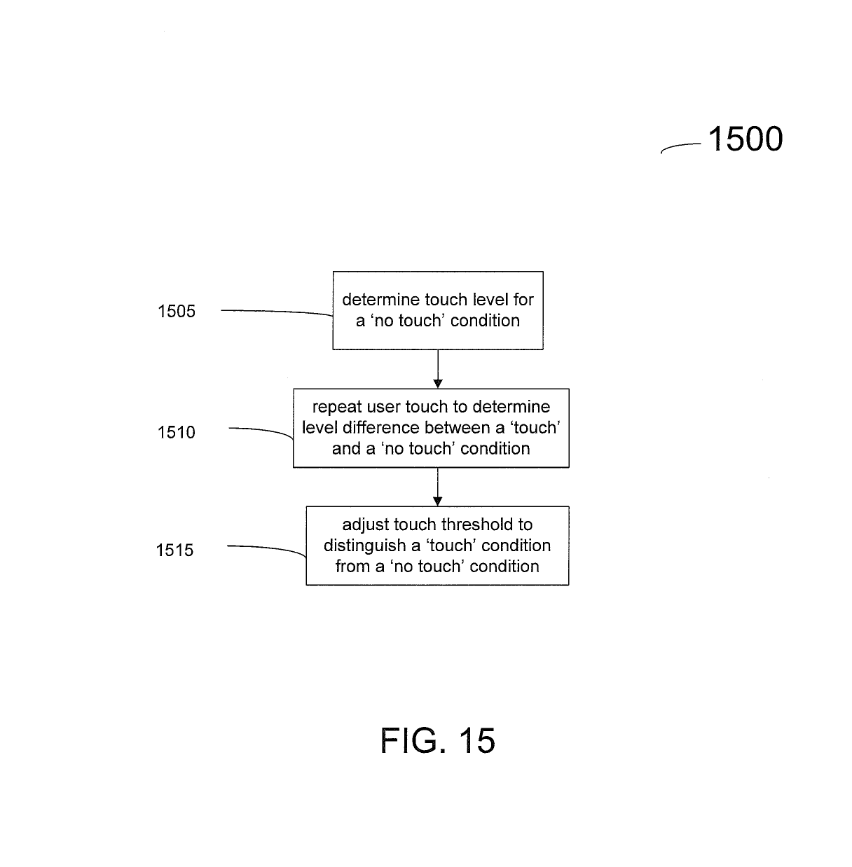

FIG. 15 illustrates a flow chart of method 1500 to calibrate touch sensitive device 102, according to some embodiments. In step 1505 a touch level ‘tnt’ is determined for a ‘no touch’ condition, such as illustrated in configuration 100A (cf. FIG. 1A). According to some embodiments, selecting a touch level higher than zero (0) may avoid perturbation of a gesture identification method by noise and background drifts in the signal provided by device 102. In some embodiments, step 1505 may include raising a threshold sensitivity value in device 102 while the device is not touched by the user, until a touch is detected. At this point, the sensitivity value may be gradually reduced to a desired point above zero (0). The sensitivity value is the touch level ‘tnt’ stored in device 102. In step 1510 a signal level difference is established by measuring the output of device 102 under repeated ‘touch’ and ‘no touch’ events. In step 1515 a touch threshold ‘tth’ to distinguish a ‘touch’ condition from a ‘no touch’ condition is determined. In some embodiments, tth may be the same as Tt, described above in relation to FIG. 1C. In some embodiments, the value of tth may be a mid point in a linear scale between the signal levels at ‘touch’ and ‘no touch’ conditions, as determined in step 1510. Some embodiments consistent with calibration method 1500 may include a nonlinear combination of the ‘touch’ and ‘no touch’ signal levels from step 1510 to arrive at the value of tth. For example, for device 102 being a capacitive device, the value of tth may be closer to the ‘no touch’ signal level (ntsl) than to the ‘touch’ signal level (tsp. In some embodiments of calibration method 1500, the value of tth may be obtained using the following formula:

$$tth = ntsl + ( \frac{tsl - ntsl}{7.7} ) \cdot {log}_{10} ( tsl - ntsl ) \qquad ( 1 )$$

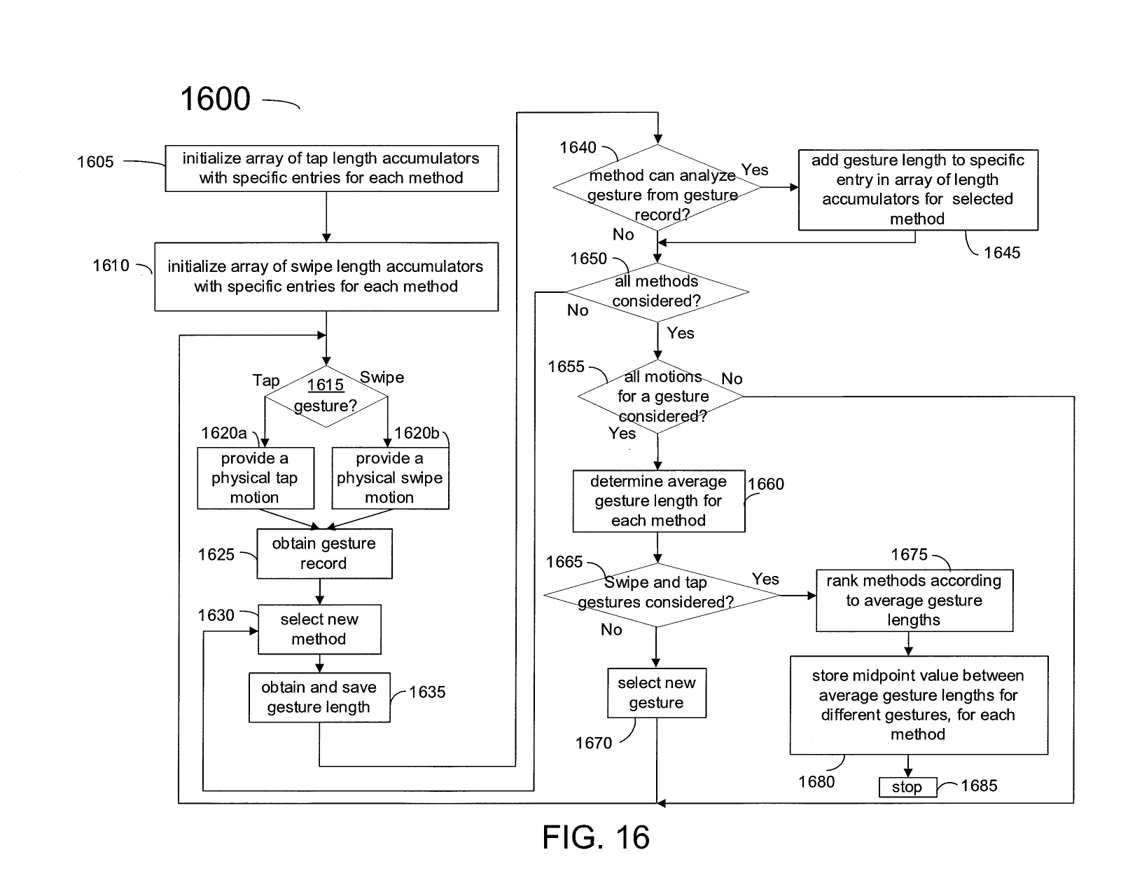

FIG. 16 illustrates a flow chart of method 1600 for ranking gesture interpretation methods in touch sensitive device 102 according to some embodiments. Step 1605 initializes an array of tap length accumulators with specific entries for each gesture interpretation method. In some embodiments, step 1605 sets to zero (0) each entry of the lengths array. The array has a dimension equal to the total number of gesture interpretation methods to be ranked, according to some embodiments consistent with method 1600. Step 1610 initializes an array of swipe length accumulators with specific entries for each gesture interpretation method to be ranked. More generally, according to embodiments consistent with method 1600 for each gesture desired to be recognized, an array of length accumulators is created having a number of entries equal to the total number of identification methods used. ‘Tap’ and ‘swipe’ gestures are used in FIG. 16 for illustrative purposes only. Some embodiments may use more gestures, or different gestures.

Step 1615 decides whether a swipe gesture or a tap gesture will be entered for ranking. Step 1620a provides a physical tap on device 102 by finger 120, if a tap gesture is to be entered for ranking. Step 1620b provides a physical swipe on device 102 by finger 120 if a swipe gesture is to be entered for ranking. Steps 1625 and 1630 are as described in detail above in relation to steps 1205 and 1215 in method 1200, respectively (cf. FIG. 12). Step 1635 obtains and stores gesture length |V| for the method selected in step 1630. Step 1640 queries whether or not the selected identification method is able to analyze the gesture from the gesture record. If the identification method is not able to analyze the gesture record then method 1600 is repeated from step 1630 when there are more identification methods to be used, according to a query in step 1650. If there are no more identification methods to be considered, then method 1600 is continued in step 1655.

When the identification method is able to analyze the gesture according to step 1640, then gesture length ‥V‥ is added to the specific entry in the array of length accumulators in step 1645. According to some embodiments, the specific entry in the array of length accumulators corresponds to the identification method selected in step 1630. In some embodiments, the array of length accumulators may be the array of ‘tap’ length accumulators if a tap gesture is selected in step 1615. In some embodiments, the array of length accumulators may be the array of ‘swipe’ length accumulators of a swipe gesture is selected in step 1615.

Step 1655 queries whether or not all physical motions for the gesture selected in step 1615 have been considered. The total number of physical motions may be 20 ‘taps’ and 20 ‘swipes’, or any other number, as desired. Furthermore, some embodiments may use the same number of physical ‘taps’ as the number of physical ‘swipes.’ Some embodiments consistent with method 1600 may use a different number of physical ‘taps’ than the number of physical ‘swipes.’

If step 1655 determines that more physical motions need to be considered, then method 1600 is repeated from step 1615. If all motions for a given gesture have been considered according to step 1655, then method 1600 continues in step 1660.

In step 1660 an average gesture length <|V|> for each method is determined. In some embodiments, <|V|> is determined in step 1660 by dividing the value of |V| provided in step 1645 by the total number of physical motions executed by step 1620 corresponding to the selected gesture. A separate count is kept for either ‘taps’ or ‘swipes.’ For example, if a tap gesture is being calibrated according to step 1615, then step 1660 obtains <|V|> dividing |V| by the number of taps performed for the interpretation method selected. Likewise, if a swipe gesture is being calibrated according to step 1615, then step 1660 obtains <|V|> dividing |V| by the number of swipes performed for the interpretation method selected.

Step 1665 determines whether both ‘tap’ and ‘swipe’ gestures have been considered. If only one set of either ‘tap’ gestures or ‘swipe’ gestures has been considered, then step 1670 selects the gesture set that needs to be considered and method 1600 is repeated from step 1615. If step 1665 determines that both ‘tap’ and ‘swipe’ gestures have been considered, then step 1675 ranks all the identification methods considered. In some embodiments, step 1675 uses the value of <|V|> provided in each entry of the lengths array for ranking the different identification methods. For example, step 1675 may consider for each identification method the difference: delta_method (Δ_{method})=<|V|>_{swipe}−<|V|>ₜₐₚ. In some embodiments, step 1675 ranks the identification methods higher up in quality according to a greater value of delta_method.

According to some embodiments of method 1600, apart from providing a ranking of the identification methods, step 1680 stores a midpoint value ‘mid_point’ between <|V|>ₜₐₚ and <|V|>_{swipe} for each method. Method 1600 is stopped in step 1685 after step 1680 is completed. The value of mid_point may be used for discrimination between a tap and a swipe gesture when using the specific identification method.

Although the description of method 1600 consistent with FIG. 16 makes use of ‘tap’ and swipe' gestures, other gestures may be included. Embodiments consistent with method 1600 may include more than ‘tap’ and ‘swipe’ gestures in the ranking method. In a broader sense, the steps described in relation to ‘tap’ and ‘swipe’ gestures in FIG. 16 may be extended to include other types of finger motions.

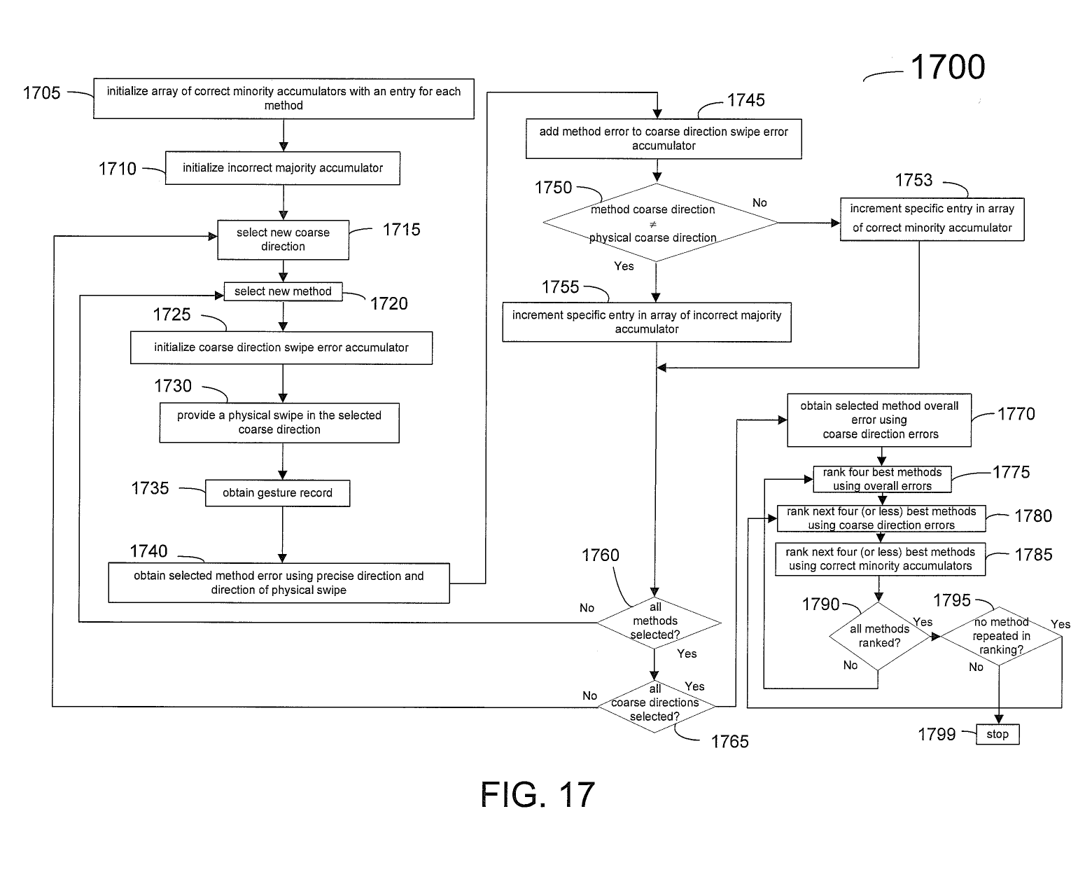

FIG. 17 illustrates a flow chart of method 1700 for ranking gesture interpretation methods in a touch sensitive device according to some embodiments. Step 1705 initializes an array of correct minority accumulators having an entry for each gesture interpretation method to be considered. According to some embodiments, step 1705 sets every entry of the array of correct minority accumulators to zero (0). Step 1710 initializes an incorrect majority accumulator. According to some embodiments, step 1710 sets the incorrect majority accumulator to zero (0).

In step 1715 a specific coarse direction is selected. For example, any one of the eight (8) different coarse directions in chart 300 may be selected in step 1720 (cf. FIG. 3). Step 1720 is as described in detail above in relation to step 1215 in method 1200 (cf. FIG. 12). Step 1725 initializes a coarse direction swipe error accumulator. In some embodiments step 1725 sets the coarse direction swipe error accumulator to zero (0). Step 1730 provides a physical ‘swipe’ gesture from finger 120 on device 102 in the coarse direction selected according to step 1720. Step 1735 is as described in detail in relation to step 1205 in method 1200 above (cf. FIG. 12). Step 1740 obtains an error value E for the identification method selected according to step 1715. In some embodiments, step 1740 may use the value dir 305 obtained by the selected identification method, and the coarse direction selected in step 1720. In some embodiments of method 1700, error E may be obtained as the difference between dir 305 and the nominal value of the coarse direction selected in step 1715, to find E. The nominal value of the coarse direction selected in step 1715 may be the angle corresponding to the midpoint for the coarse direction in chart 300 (cf. FIG. 3).

Step 1745 adds error E for the selected identification method to the coarse swipe error accumulator. Step 1750 queries whether or not the coarse direction obtained by the selected identification method from dir 305 is different from the coarse direction selected in step 1715. If the identification method coarse direction is the same as that selected in step 1715, then step 1753 increments the specific entry in the array of correct minority accumulators. In some embodiments, step 1753 increments the specific entry by an amount equal to the incorrect majority accumulator.

If the identification method coarse direction is different from that selected in step 1715, then step 1755 increments the incorrect majority accumulator. In some embodiments, step 1755 increments the incorrect majority accumulator by one (1). According to embodiments consistent with method 1700, the incorrect majority accumulator is an integer and the array of correct minority accumulators includes entries having integer values. Step 1760 queries whether or not all methods in the plurality of gesture interpretation methods have been considered. If not, method 1700 is repeated from step 1720. Otherwise, method 1700 continues in step 1765. Step 1765 queries whether or not all coarse directions have been selected. If coarse directions remain to be considered, then method 1700 is repeated from step 1715. If no more coarse directions remain to be considered step 1770 obtains an overall error (OE) for the selected method using the coarse direction errors E. Some embodiments consistent with method 1700 may perform step 1770 by adding the errors E for each of the different coarse directions selected in step 1715, for a specific identification method selected in step 1720.

Step 1775 ranks the four best methods using OEs provided in step 1770. The ranking is inversely proportional to the value of the error. That is, an identification method is better than another if its OE is smaller, according to step 1770. Step 1780 ranks the next four best identification methods using the coarse direction errors obtained for each identification method. In some embodiments, step 1780 ranks the identification methods in terms of the lowest E obtained in step 1745 among all the coarse directions considered, for each of the identification methods considered. Step 1780 may be performed taking care not to repeat in the overall ranking any of the identification methods already ranked in step 1775.

Step 1785 ranks the next four best methods using correct minority accumulators. For example, in step 1785 an identification method may be ranked higher if it has a higher correct minority accumulator value. Steps 1790 and 1795 ensure that all identification methods considered have been ranked, and that no identification method is repeated in the ranking. After the answer to the query in step 1790 is ‘yes’ and the answer in step 1795 is ‘no,’ method 1700 is stopped in step 1799. If step 1795 determines that an identification method is repeated then method 1700 is repeated from step 1780, making sure that if an identification method appears again in the ranking process, then the identification method is eliminated from the lower ranking position, and the lower ranking position is left vacant. Thus, in some embodiments after the four best methods have been determined in step 1775, less than four methods may be ranked below the first four methods in step 1780. Likewise, fewer than four methods may be ranked in step 1785 below the identification methods ranked in step 1780.

In the figures, elements having the same designation have the same or similar functions. The embodiments described above are exemplary only. One skilled in the art may recognize various alternative embodiments from those specifically disclosed. Those alternative embodiments are also intended to be within the scope of this disclosure. As such, the disclosure is limited only by the following claims.

1. A method for recognizing a gesture made on a touch sensitive device configured to detect touch motions comprising:
obtaining a record of positions for a touch from a touch device using a pad in the touch sensitive device;
initializing a vote count to select each of a plurality of gestures;
selecting a method from a plurality of gesture identification methods, and for each of the selected methods:
obtaining a measure of the touch from the touch device using the record of positions;
updating the vote count according to the obtained measure;
determining the gesture from the touch when a plurality of votes is obtained for the vote count for one of the plurality of gestures; and
determining the gesture from the touch according to the gesture having a maximum vote count.

2. The method of claim 1 wherein determining the gesture from the touch when a plurality of votes is obtained comprises comparing a pre-selected value for the plurality of votes to an absolute value of the vote count.

3. The method claim 1 wherein updating the vote count comprises comparing the measure of the touch to a pre-selected threshold.

4. The method of claim 3 wherein the measure of the touch is a length of the touch and updating the vote count further comprises:
increasing the vote count if the length of the touch is smaller than the pre-selected threshold; and
decreasing the vote count if the length of the touch is not smaller than the pre-selected threshold.

5. The method of claim 4 wherein the gesture is one of the group of gestures consisting of a tap gesture and a swipe gesture.

6. The method of claim 5 wherein a tap gesture is reported when the vote count is greater than zero and a swipe gesture is reported when the vote count is not greater than zero.

7. The method of claim 1 wherein the record of positions comprises at least a touch position and a touch strength for each touch of the touch device on the pad.

8. The method of claim 1 wherein the plurality of gesture identification methods comprises at least one method comprising:
finding a resulting vector from an initial position to a final position in the record of positions; and
obtaining a measure of the touch comprises obtaining a length and a direction of the resulting vector.

9. The method of claim 1 wherein the plurality of gesture identification methods comprises at least one method comprising:
forming an envelope comprising the points in the record of positions and finding a resulting vector passing from a center point of the envelope and extending to the envelope borders in a direction formed from an initial position to a final position in the record of positions; and
obtaining a measure of the gesture comprises obtaining a length and a direction of the resulting vector.

10. The method of claim 9 wherein the direction of the resulting vector comprises a precise direction and a coarse direction.

11. The method of claim 7 wherein the plurality of gesture identification methods comprises at least one method comprising:
splitting the record of positions into a begin phase and an end phase at a landmark position;
finding a resulting vector from a point obtained from the begin phase to a point obtained from the end phase; and
obtaining a measure of the touch comprises obtaining a length and a direction of the resulting vector.

12. The method of claim 11 wherein the begin phase includes a first position in the record of positions and the end phase includes a last position in the record of positions.

13. The method of claim 12 wherein the landmark position is the position having a largest touch strength in the record of positions.

14. The method of claim 12 wherein the landmark position is a middle sequence position in the record of positions.

15. The method of claim 12 wherein the landmark position is the closest point in the record of positions to a center point of an envelope comprising the positions in the record of positions.

16. The method of claim 12 wherein the landmark position is the closest position in the record of positions to an average position in the record of positions.

17. The method of claim 11 wherein the point obtained from the begin phase is an average position of the positions in the begin phase and the point obtained from the end phase is an average position of the positions in the end phase.

18. The method of claim 11 wherein the position obtained from the begin phase has the lowest strength in a strength percent level of the begin phase, and the position obtained from the end phase has the lowest strength in the same strength percent level of the end phase.

19. The method of claim 18 wherein the strength percent level of the begin phase includes points in the begin phase having a touch strength greater than the touch strength of a first point in the begin phase, by the percent level of the strength difference between the first point in the begin phase and a strongest point in the record of positions.

20. The method of claim 18 wherein the strength percent level of the end phase includes points in the end phase having a touch strength greater than the touch strength of a last point in the end phase, by the percent level of the strength difference between the last point in the end phase and a strongest point in the record of positions.

21. The method of claim 18 wherein the percent level is selected from the group consisting of 25%, 50%, and 75%.

22. A method to determine a gesture direction in a touch sensitive device comprising:
obtaining a gesture record;
selecting a method from a plurality of gesture identification methods, and for each of the selected methods:
obtaining a gesture direction from the gesture record;
updating a directions array using the gesture direction; and
determining the gesture direction using the directions array.

23. The method of claim 22 wherein the directions array contains one entry for each of a coarse direction in a table of coarse directions.

24. The method of claim 23 wherein updating the directions array comprises adding a count value in an entry of the directions array having the coarse direction that comprises the gesture direction.

25. The method of claim 24 wherein determining the gesture direction comprises selecting the coarse direction having an entry with a largest count value in the directions array.

26. The method of claim 22 further comprising, for each of the selected methods from the plurality of gesture identification methods:
obtaining a gesture length;
updating an array of lengths; and
updating a direction accumulator;
determining the gesture direction further using the direction accumulator; and
reporting a gesture length using the array of lengths and the gesture direction.

27. The method of claim 26 wherein the array of lengths contains one entry from each of a coarse direction in a table of coarse directions.

28. The method of claim 27 wherein updating the array of lengths comprises replacing an entry in the array of lengths with the gesture length, when the gesture length is greater than the existing entry in the array of lengths, wherein:
the entry in the array of lengths corresponds to the coarse direction comprising the gesture direction.

29. The method of claim 26 wherein updating the direction accumulator comprises adding the gesture direction to the direction accumulator.

30. The method of claim 29 wherein determining the gesture direction comprises dividing the direction accumulator by a largest entry in the directions array.

31. The method of claim 30 wherein determining the gesture direction further comprises reporting the coarse direction having the largest entry in the directions array.

32. A method to calibrate a touch sensitive device comprising:
determining a touch level for a ‘no touch’ condition;
determining a touch level for a ‘touch condition’;
determining a level difference between a ‘touch’ and a ‘no touch’ condition; and
obtaining a touch strength threshold to distinguish a ‘touch’ condition from a ‘no touch’ condition.

33. The method of claim 32 wherein the touch level for a ‘no touch’ condition is greater than noise and background drifts in the touch sensitive device.

34. The method of claim 32 wherein the touch strength threshold is approximately a mid point in a linear scale between the touch level for a ‘no touch’ condition and the touch level for a ‘touch’ condition.

35. The method of claim 32 wherein the touch strength threshold is a nonlinear combination of the touch level for a ‘no touch’ condition and the touch level for a ‘touch’ condition.

36. The method of claim 35 wherein the nonlinear combination includes a logarithmic scale.

37. A method for ranking gesture interpretation methods in a touch sensitive device comprising:
selecting a plurality of gestures to be interpreted;
selecting a plurality of gesture interpretation methods to be ranked;
providing a selected number of physical gestures corresponding to each of the plurality of gestures;
updating a length array for each of the plurality of gestures to be interpreted, for each of the physical gestures provided; and
ranking each of the plurality of gesture interpretation methods according to an entry in the length array.

38. The method of claim 37 wherein the plurality of gestures includes a tap gesture and a swipe gesture performed on the touch sensitive device.

39. The method of claim 37 wherein the length array includes an entry for each of the plurality of gesture interpretation methods to be ranked.

40. The method of claim 39 further comprising determining a mid point between a corresponding entry in the length arrays for two of the plurality of physical gestures to be interpreted.

41. The method of claim 40 wherein the mid point is used as a threshold to differentiate between each of the two of the plurality of gestures to be interpreted.

42. A method for ranking gesture interpretation methods in a touch sensitive device comprising:
selecting a plurality of gesture interpretation methods to be ranked;
selecting a plurality of physical directions;
providing a physical gesture corresponding to a pre-selected type in one of the plurality of physical directions;
obtaining a gesture record from the physical gesture;
for each of the plurality of gesture interpretation methods:
updating an array of correct minority accumulators;
updating an incorrect majority accumulator;
obtaining an overall error; and
ranking the plurality of gesture interpretation methods.

43. The method of claim 42 wherein updating an array of correct minority accumulators and updating an incorrect majority accumulator for each method comprise:
comparing a coarse direction with a coarse direction comprising the physical direction updating a coarse direction error accumulator for each method; and
increasing an entry in the array of correct minority accumulators when the coarse direction is equal to the coarse direction comprising the physical direction;
increasing the incorrect majority accumulator when the coarse direction is different from the coarse direction comprising the physical direction.

44. The method of claim 43 wherein the array of correct minority accumulators includes one entry for each of the plurality of gesture interpretation methods and:
increasing an entry in the array of correct minority accumulators comprises adding the incorrect minority accumulator to the entry in the array of correct minority accumulators;
increasing the incorrect majority accumulator comprises adding one (1) to the incorrect majority accumulator.

45. The method of claim 43 wherein updating the coarse direction error accumulator comprises:
obtaining a precise direction using one of the gesture interpretation methods; and
comparing the precise direction with the physical direction.

46. The method of claim 45 wherein for each of the plurality of gesture interpretation methods obtaining the overall error comprises adding the coarse direction error for each of the plurality of physical directions.

47. The method of claim 42 wherein ranking the plurality of gesture interpretation methods comprises the steps of:
providing a first tier including methods having a lowest overall error;
providing a second tier including methods having a lowest coarse direction error accumulator; and
providing a third tier including methods having a highest correct minority accumulator.

48. The method of claim 47 wherein each of the first, second, and third tier include no more than four methods.

49. The method of claim 48 wherein each method in the plurality of gesture interpretation methods is included only in one of the first, second, and third tiers.

50. A touch sensitive device, comprising:
a touch pad configured to provide a record of positions for a touch motion made on the touch pad;
a memory circuit to store the record of positions, the memory circuit including a set of executable instructions;
a processor circuit to execute the set of executable instructions using the stored record of positions; wherein
the set of executable instructions comprises instructions for recognizing the touch motion from one of a plurality of gestures using a vote count and a plurality of gesture identification methods, wherein the vote count is updated for each of the plurality of gesture identification methods.

51. The touch sensitive device of claim 50 wherein the touch pad comprises a capacitively coupled sensor.

52. The touch sensitive device of claim 50 wherein the touch pad is an optically coupled sensor.

53. A method for ranking a plurality of gesture identification methods for gesture recognition in a touch sensitive device configured to detect touch motions comprising:
initializing an array of measure values for each of a plurality of gestures, each array having an entry for each of a plurality of gesture identification methods;
providing a number of identifiable touch motions corresponding to each of the plurality of gestures;
updating each of the arrays of measure values for each of a plurality of gestures using measures provided by each of the plurality of gesture identification methods;
ranking the plurality of gesture identification methods using differences in the array of measures between two different gestures from the plurality of gestures.

54. The method of claim 53 wherein the plurality of gestures comprise a tap gesture and a swipe gesture.

55. The method of claim 53 wherein initializing an array of measure values comprises initializing an array of correct minority accumulators with an entry for each of the plurality of gesture identification methods and an array of incorrect majority accumulators with an entry for each of the plurality of gesture identification methods.

56. The method of claim 55 wherein the measures provided by each of the gesture identification methods comprise an array of coarse direction errors having a number of entries equal to a number of coarse directions.
